(19) United States
(12) Patent Application Publication
(10) Pub. No.: US 2014/0005031 A1
(43) Pub. Date: Jan. 2, 2014

(54) SPHERICAL MATERIAL BASED ON HETEROPOLYANIONS TRAPPED IN A MESOSTRUCTURED OXIDE MATRIX AND USE THEREOF AS CATALYST IN HYDROCARBON REFINING PROCESSES

(71) Applicants: Alexandra Chaumonnot, Lyon (FR); Clement Sanchez, Bures-Sur-Yvette (FR); Cedric Boissiere, Paris (FR); Frederic Colbeau-Justin, Ivry-Sur-Seine (FR); Karin Marchand, Lyon (FR); Elodie Devers, Lyon (FR); Audrey Bonduelle, Francheville (FR); Denis Uzio, Saint Genis Laval (FR); Antoine Daudin, Corbas (FR); Bertrand Guichard, Izeaux (FR); Denis Uzio, Saint Genis laval (FR); Antoine Daudin, All Maryse (FR)

(72) Inventors: Alexandra Chaumonnot, Lyon (FR); Clement Sanchez, Bures-Sur-Yvette (FR); Cedric Boissiere, Paris (FR); Frederic Colbeau-Justin, Ivry-Sur-Seine (FR); Karin Marchand, Lyon (FR); Elodie Devers, Lyon (FR); Audrey Bonduelle, Francheville (FR); Denis Uzio, Saint Genis Laval (FR); Antoine Daudin, Corbas (FR); Bertrand Guichard, Izeaux (FR); Denis Uzio, Saint Genis laval (FR); Antoine Daudin, All Maryse (FR)

(73) Assignees: CENTRE NATIONAL DE LA RECHERCHE SCIENTIFIQUE, Paris Cedex 16 (FR); IFP ENERGIES NOUVELLES, Rueil Malmaison Cedex (FR); UNIVERSITE PIERRE ET MARIE CURIE, Paris Cedex 05 (FR)

(21) Appl. No.: 13/995,508

(22) PCT Filed: Dec. 15, 2011
(86) PCT No.: PCT/FR2011/000654

§ 371 Date: Sep. 23, 2013

(30) Foreign Application Priority Data
Dec. 22, 2010 (FR) 10/05030

(51) Int. Cl. B01J 27/199; B01J 27/19; B01J 27/188; B01J 23/882

(52) U.S. Cl. CPC B01J 27/199; B01J 23/882; B01J 27/19; B01J 27/188
USPC 502/64; 208/216 R; 208/217; 208/111.3; 208/111.35; 208/112; 208/99; 585/270; 585/266; 585/733; 502/248; 502/255; 502/254; 502/209; 502/211; 502/210

(57) ABSTRACT

Inorganic material having at least two elementary spherical particles, each of said spherical metallic particles: a polyoxometallate with formula (XₓMₘO_{y}Hₕ)^{q-}, where H is hydrogen, O is oxygen, X is phosphorus, silicon, boron, nickel or cobalt and M is one or more vanadium, niobium, tantalum, molybdenum, tungsten, iron, copper, zinc, cobalt and nickel, x is 0, 1, 2 or 4, m is 5, 6, 7, 8, 9, 10, 11, 12 or 18, y is 17 to 72, h is 0 to 12 and q is 1 to 20.

The present invention relates to the field of inorganic oxide materials, in particular to those containing transition metals, having an organized and uniform porosity in the mesopore domain. It also relates to the preparation of these materials which are obtained using the “aerosol” synthesis technique. It also relates to the use of these materials, following sulphurization, as catalysts in various processes relating to the fields of hydrotreatment, hydroconversion and the production of hydrocarbon feeds.

### PRIOR ART

The composition and use of catalysts for the hydroconversion (HDC) and hydrotreatment (HDT) of hydrocarbon feeds are respectively described in the work “Hydrocracking Science and Technology”, 1996, J. Scherzer, A. J. Gruia, Marcel Dekker Inc and in the article by B. S Clausen, H. T. Topsøe, F. E. Massoth, from the work “Catalysis Science and Technology”, 1996, volume 11, Springer-Verlag. Thus, those catalysts are generally characterized by a hydrodehydrogenating function provided by the presence of an active phase based on at least one metal from group VIB and/or at least one metal from group VB and optionally at least one metal from group VIII of the periodic table of the elements. The most usual formulations are of the cobalt-molybdenum (CoMo), nickel-molybdenum (NiMo) and nickel-tungsten (NiW) type. Such catalysts may be in the bulk form or in the supported state, which then uses a porous solid. After preparation, at least one metal from group VIB and/or at least one metal from group VB and optionally at least one metal from group VIII present in the catalytic composition of said catalysts are usually in the oxide form. The active and stable form for HDC and HDT processes is the sulphurized form, and so such catalysts undergo a sulphurization step.

The skilled person is generally aware that good catalytic performances in the fields of application mentioned above are a function of 1) the nature of the hydrocarbon feed to be treated, 2) the process used, 3) the functional operating conditions selected, and 4) the catalyst used. In this latter case, it is also known that a catalyst with a high catalytic potential is characterized by 1) an optimized hydrodehydrogenating function (associated active phase completely dispersed at the surface of the support and having a high metal content) and 2) in the particular case of processes using hydroconversion reactions (HDC), by a good balance between said hydrodehydrogenating function and the cracking function provided by the acid function of a support. In general, irrespective of the nature of the hydrocarbon feed to be treated, the reagents and reaction products should also have satisfactory access to the active sites of the catalyst which should also have a large active surface area, which means that specific constraints arise in terms of the structure and texture of the oxide support present in said catalysts. This latter point is particularly critical in the case of the treatment of “heavy” hydrocarbon feeds.

The usual methods leading to the formation of the hydrodehydrogenating phase of HDC and HDT catalysts consist in depositing molecular precursor(s) of at least one group VIB metal and/or at least one metal from group VB and optionally at least one metal from group VIII on an oxide support using the technique known as “dry impregnation”, followed by steps for maturation, drying and calcining, resulting in the formation of the oxidized form of said metal(s) employed. Next, a final step for sulphurizing, generating the active hydrodehydrogenating phase, is carried out as mentioned above.

The catalytic performances of the catalysts obtained using such conventional synthesis protocols have been studied in depth. In particular, it has been shown that for relatively high metal contents, phases appear which are refractory to sulphurization, formed consecutively to the calcining step (sintering phenomenon) (B. S. Clausen, H. T. Topsøe, and F. E. Massoth, from the work “Catalysis Science and Technology”, 1996, volume 11, Springer-Verlag). As an example, in the case of catalysts of the CoMo or NiMo type supported on an alumina type support, these are 1) crystallites of MoO₃, NiO, CoO, CoMoO₄ or Co₃O₄, of a size sufficient to be detected in XRD, and/or 2) species of the Al₂(MoO₄)₃, CoAl₂O₄ or NiAl₂O₄ type. The three species cited above containing the element aluminium are well known to the skilled person. They result from the interaction between the alumina support and precursor salts of the active hydrodehydrogenating phase in solution, which in practice results in a reaction between Al³⁺ ions extracted from the alumina matrix and said salts in order to form Anderson heteropolyanions with formula [Al(OH)₆Mo₆O₁₈]³⁻, which are themselves precursors of phases which are refractory to sulphurization. The presence of all of these species results in a non-negligible indirect loss of catalytic activity of the associated catalyst because not all of the elements belonging to at least one metal from group VIB and/or at least one metal from group VB and optionally at least one metal from group VIII are used to their maximum potential since a portion thereof is immobilized in low activity or inactive species.

The catalytic performances of the conventional catalysts described above could thus be improved, in particular by developing novel methods for the preparation of these catalysts which could be used to:
1) ensure good dispersion of the hydrodehydrogenating phase, in particular for high metal contents (for example by controlling the size of the particles based on transition metals, maintaining the properties of those particles after heat treatment, etc.);
2) limit the formation of species which are refractory to sulphurization (for example by obtaining a better synergy between the transition metals forming the active phase, controlling the interactions between the hydrodehydrogenating active phase (and/or its precursors) and the porous support employed, etc.);
3) ensure good diffusion of reagents and reaction products while keeping the developed active surface areas high (optimization of chemical, textural and structural properties of the porous support).

In order to satisfy the needs expressed above, hydroconversion and hydrotreatment catalysts have been developed wherein the precursors of the active hydrodehydrogenating phase are formed from heteropolyanions (HPA), for example heteropolyanions based on cobalt and molybdenum (CoMo systems), nickel and molybdenum (NiMo systems), nickel and tungsten (NiW), nickel, vanadium and molybdenum (NiMoV systems) or phosphorus and molybdenum (PMo). As an example, patent application FR 2.843.050 discloses a hydrorefining and/or hydroconversion catalyst comprising at least one element from group VIII and at least molybdenum and/or tungsten present in the oxide precursor at least partially in the form of heteropolyanions. In general, the heteropolyanions are impregnated onto an oxide support.

About a decade ago, other catalysts with supports which have a controlled hierarchical porosity were developed. In the context of applications pertaining to the fields of hydrotreatment, hydroconversion and the production of hydrocarbon feeds, apart from the accessibility (linked to pore size)/developed active surface (linked to the specific surface area) compromise, control of which is desirable, it is important to control parameters such as pore length, the tortuosity or the connectivity between the pores (defined by the access number of each cavity). The structural properties linked to a periodic arrangement and to a particular morphology of the pores are parameters which are essential to control. As an example, US patent 2007/152181 teaches that for the transformation of various oil cuts, it is advantageous to use mesostructured alumina type catalyst supports developing a large specific surface area and a homogeneous pore size distribution.

### SUMMARY OF THE INVENTION

The present invention concerns an inorganic material constituted by at least two elementary spherical particles, each of said spherical particles comprising metallic particles in the form of a polyoxometallate with formula (XₓMₘO_{y}Hₕ)^{q-} where H is a hydrogen atom, 0 is an oxygen atom, X is an element selected from phosphorus, silicon, boron, nickel and cobalt and M is one or more elements selected from vanadium, niobium, tantalum, molybdenum, tungsten, iron, copper, zinc, cobalt and nickel, x being equal to 0, 1, 2 or 4, m being equal to 5, 6, 7, 8, 9, 10, 11, 12 or 18, y being in the range 17 to 72, h being in the range 0 to 12 and q being in the range 1 to 20 (y, h and q being whole numbers), said metallic particles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns. The general formula (HₕXₓMₘO_{y})^{q-} is denoted formula (I) in the remainder of the description.

The material of the invention is prepared using a particular synthesis technique known as an “aerosol” technique.

After sulphurization, the mesostructured inorganic material of the invention is used as a catalyst in various processes for the transformation of hydrocarbon feeds, in particular in processes for the hydrodesulphurization of gasoline and gas oil cuts, processes for the hydrocracking and hydroconversion of heavy hydrocarbon feeds, processes for the hydrotreatment of heavy hydrocarbon feeds and hydrocarbon feeds containing triglycerides.

### INTEREST OF THE INVENTION

The material of the invention comprising metallic particles in the form of a polyoxometallates, preferably in the form of heteropolyanions, trapped in the mesostructured matrix of each of the elementary spherical particles constituting said material is an advantageous catalytic precursor. It simultaneously has properties relevant to the presence of polyoxometallates, preferably heteropolyanions, in particular better dispersion of the active phase, a better synergy between the metallic species, a reduction in the phases refractory to sulphurization, and structural, textural and optionally acid-basic properties and redox properties that are specific to mesostructured materials based on the oxide of at least one element Y, in particular the non-limiting transfer of reagents and reaction products and the high active surface area value. Polyoxometallates, preferably heteropolyanions, are precursor species of the active sulphurized phase present in the catalyst obtained from the material of the invention after sulphurization.

The diffusion properties of the reagents and the reaction products associated with the inorganic material of the invention constituted by elementary spherical particles with a maximum diameter of 200 μm are enhanced with respect to those of other mesostructured materials which are known in the art and not obtained by the aerosol method and in the form of elementary particles which are not homogeneous in shape, i.e. irregular, and with a dimension of much more than 500 nm. In addition to the specific properties of polyoxometallates, preferably heteropolyanions (HPA), on the one hand and also to the mesostructured oxide matrix present in each of the spherical particles of the material of the invention, trapping the polyoxometallates, preferably heteropolyanions, in the mesostructured oxide matrix generates additional favourable technical effects such as control over the size of said metallic particles in the form of a polyoxometallates, an increase in the thermal stability of the polyoxometallates, preferably heteropolyanions, and the development of original HPA/support interactions.

In addition, the preparation process using the aerosol method of the invention can be used to easily produce a variety of precursors of sulphurized catalysts, in a single step (one pot), which are based on polyoxometallates (in particular heteropolyanions).

In addition, compared with known syntheses of mesostructured materials which do not use the aerosol method, the preparation of the material of the invention is carried out continuously, the preparation period is reduced (a few hours as opposed to 12 to 24 hours using autoclaving) and the stoichiometry of the non-volatile species present in the initial solution of the reagents is maintained in the material of the invention.

### DISCLOSURE OF THE INVENTION

The present invention concerns an inorganic material constituted by at least two elementary spherical particles, each of said spherical particles comprising metallic particles in the form of a polyoxometallate with formula (XₓMₘO_{y}Hₕ)^{q-} where H is a hydrogen atom, O is an oxygen atom, X is an element selected from phosphorus, silicon, boron, nickel and cobalt and M is one or more elements selected from vanadium, niobium, tantalum, molybdenum, tungsten, iron, copper, zinc, cobalt and nickel, x being equal to 0, 1, 2 or 4, m being equal to 5, 6, 7, 8, 9, 10, 11, 12 or 18, y being in the range 17 to 72, h being in the range 0 to 12 and q being in the range 1 to 20 (y, h and q being whole numbers), said metallic particles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns. The general formula (HₕXₓMₘO_{y})^{q-} is denoted formula (I) in the remainder of the description. In the context of the present invention, the definition of this formula means that the elements H, X, M and O are present in the structure of the polyoxometallates.

In accordance with the invention, the element Y present in the form of an oxide in the mesostructured matrix included in each of said spherical particles of the material of the invention is selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements and preferably, said element Y present in the oxide form is selected from the group constituted by silicon, aluminium, titanium, zirconium, gallium, germanium and cerium and a mixture of at least two of these elements. Still more preferably, said element Y present in the oxide form is selected from the group constituted by silicon, aluminium, titanium, zirconium and a mixture of at least two of these elements. In accordance with the invention, said mesostructured matrix is preferably constituted by aluminium oxide, silicon oxide or a mixture of silicon oxide and aluminium oxide. In the preferred case in which said mesostructured matrix is a mixture of silicon oxide and aluminium oxide (aluminosilicate), said matrix has a Si/Al molar ratio equal to at least 0.02, preferably in the range 0.1 to 1000 and highly preferably in the range 1 to 100.

Said matrix based on an oxide of at least said element Y is mesostructured: it has a porosity which is organized on the mesopore scale for each of the elementary particles of the material of the invention, i.e. an organized porosity on the pore scale with a uniform diameter in the range 1.5 to 50 nm, preferably in the range 1.5 to 30 nm, and still more preferably in the range 4 to 20 nm and distributed in a homogeneous and regular manner in each of said particles (mesostructuring of the matrix). The material located between the mesopores of the mesostructured matrix is amorphous and forms walls or partitions the thickness of which is in the range 1 to 30 nm, preferably in the range 1 to 10 nm. The thickness of the walls corresponds to the distance separating a first mesopore from a second mesopore, the second mesopore being the pore which is closest to said first mesopore. The organization of the mesoporosity as described above results in structuring of said matrix, which may be hexagonal, vermicular or cubic, preferably vermicular. The mesostructured matrix advantageously has no porosity in the micropore range. The material of the invention also has an interparticulate textural macroporosity.

The mesostructured matrix included in each of said spherical particles of the material of the invention contains metallic particles in the form of a polyoxometallate with formula (XₓMₘO_{y}Hₕ)^{q-} where X is an element selected from phosphorus, silicon, boron, nickel and cobalt and M is one or more elements selected from vanadium, niobium, tantalum, molybdenum, tungsten, cobalt and nickel, x being equal to 0, 1, 2, or 4; preferably, x is equal to 0, 1 or 2, m being equal to 5, 6, 7, 8, 9, 10, 11, 12 or 18, y being in the range 17 to 72, preferably in the range 23 to 42, h being in the range 0 to 12 and q being in the range 1 to 20, preferably in the range 3 and 12 (y, h and q are whole numbers). More precisely, said metallic particles are trapped in the mesostructured matrix. They have a mean dimension in the range 0.6 to 3 nm, preferably in the range 0.6 to 2 nm; still more preferably, it is greater than or equal to 0.6 nm and strictly less than 1 nm. The diameter of said metallic particles is advantageously measured by transmission electron microscopy (TEM). The absence of detection of metallic particles in TEM means that the dimension of said metallic particles is less than 1 nm. Said metallic particles trapped in the mesostructured oxide matrix included in each of said spherical particles of the material of the invention advantageously have atoms M with an oxidation number equal to +IV, +V and/or +VI. The metallic particles are trapped in the matrix in a homogeneous and uniform manner. Said metallic particles are characterized by the presence of at least one band with a wave number in the range 750 to 1050 cm⁻¹ in Raman spectroscopy. Raman spectroscopy is a technique which is well known to the skilled person.

In accordance with the invention, said metallic particles in the form of a polyoxometallate are selected from isopolyanions and heteropolyanions (HPA). The isopolyanions and the heteropolyanions trapped in the mesostructured matrix comprised in each of said spherical particles of the material of the invention have been described in full in the work Heteropoly and Isopoly Oxometallates, Pope, Eds. Springer-Verlag, 1983. Preferably, said metallic particles are heteropolyanions. Said metallic particles, preferably in the form of heteropolyanions, are salts carrying a negative charge q compensated by positively charged counter-ions of an identical or different nature. The counter-ions are advantageously provided by metallic cations, in particular cations of metals from group VIII such as Co²⁺, Ni²⁺, protons H⁺ and/or ammonium cations NH₄⁺. When all of the counter-ions are protons H⁺, the term “heteropolyacid” is generally used to designate the form in which said metallic particles are present. An example of such a heteropolyacid is phosphomolybdic acid (3H⁺, PMo₁₂O₄₀³⁻) or phosphotungstic acid (3H⁺, PW₁₂O₄₀³⁻).

In accordance with the first embodiment consisting of trapping metallic particles in the form of isopolyanions in each of said mesostructured matrices, the element X occurring in the general formula (I) above is absent and x=0. The element M is one or more elements selected from vanadium, niobium, tantalum, molybdenum, tungsten, cobalt and nickel. More preferably, the element M is one or more elements selected from vanadium, niobium, tantalum, molybdenum and tungsten. The cobalt and/or nickel as the element M in said general formula (I) is/are advantageously present as a mixture with one or more elements M selected from vanadium, niobium, tantalum, molybdenum and tungsten (partial substitution of one or more elements M=V, Nb, Ta, Mo or W by Ni and/or Co). Preferably, the m atoms of element M present in general formula (I) are all exclusively either Mo atoms, or W atoms, or a mixture of Mo and W atoms, or a mixture of W and Nb atoms, or a mixture of Mo and V atoms, or a mixture of W and V atoms, or a mixture of Mo and Co atoms, or a mixture of Mo and Ni atoms, or a mixture of W and Ni atoms. In accordance with said first embodiment, m is equal to 5, 6, 7, 8, 9, 10, 11, 12 or 18. Still more preferably, m is equal to 6, 7 or 12. In the particular case in which the element M is molybdenum (Mo), the value of m is preferably 7. In another particular case in which the element M is tungsten (W), the value of m is preferably 12. In the general formula (I), O designates the element oxygen with 17≦y≦48. q designates the charge of the isopolyanion, where 3≦q≦12, and H is the element hydrogen, where h=0 to 12. A preferred isopolyanion in accordance with said first embodiment has the formula H₂W₁₂O₄₀⁶⁻ (h=2, m=12, y=40, q=6) or again the formula Mo₇O₂₄⁶⁻ (h=0, m=7, y=24, q=6).

In accordance with the second embodiment consisting of trapping metallic particles in the form of heteropolyanions (denoted HPA) in each of said mesostructured matrices, the element X is the central atom in the heteropolyanion structure and is selected from P, Si, B, Ni and Co, with x=1 or 2. The element M is a metal atom which is advantageously in systematic octahedral coordination in the structure of the heteropolyanion. The element M is one or more elements selected from vanadium, niobium, tantalum, molybdenum, tungsten, cobalt and nickel. More preferably, the element M is one or more elements selected from vanadium, niobium, tantalum, molybdenum and tungsten. The cobalt and/or nickel as the element M in said general formula (I) is/are advantageously present as a mixture with one or more elements M selected from vanadium, niobium, tantalum, molybdenum and tungsten (partial substitution of one or more elements M=V, Nb, Ta, Mo and W by Ni and/or Co). Preferably, the m M atoms present in the general formula (I) are all exclusively either Mo atoms, or W atoms, or a mixture of Mo and W atoms, or a mixture of W and Nb atoms, or a mixture of Mo and V atoms, or a mixture of W and V atoms, or a mixture of Mo and Co atoms, or a mixture of Mo and Ni atoms, or a mixture of W and Ni atoms. In accordance with said second embodiment, m is equal to 5, 6, 7, 8, 9, 10, 11, 12 or 18 and preferably equal to 5, 6, 9, 10, 11, 12 or 18. In the general formula (I), O designates the element oxygen with y in the range 17 to 72, preferably in the range 23 to 42, q designates the charge of the heteropolyanion with 1≦q≦20, preferably 3≦q≦12, and H is the element hydrogen with h=0 to 12.

A first preferred category of heteropolyanions (second embodiment) advantageously trapped in the mesostructured matrix comprised in each of said spherical particles of the material in accordance with the invention is such that said heteropolyanions have the formula XM₆O₂₄Hₕ^{q-} (with x=l, m=6, y=24, q=3 to 12 and h=0 to 12) and/or formula X₂M₁₀O₃₈Hₕ^{q-} (with x=2, m=10, y=38, q=3 to 12 and h=0 to 12) with H, X, M, O, h, x, m, y and q having the same definitions as those given in general formula (I) above. Such heteropolyanions are termed Anderson heteropolyanions (Nature, 1937, 150, 850). They comprise 7 octahedra located in the same plane and connected together via the edges: 6 octahedra surround the central octahedron containing the heteroelement X. The heteropolyanions CoMo₆O₂₄H₆³⁻ and NiMo₆O₂₄H₆⁴⁻ are good examples of Anderson heteropolyanions trapped in each of said mesostructured matrices, the Co and the Ni respectively being the heteroelements X of the HPA structure. When they are in the form of cobalt or nickel salts (i.e. when cobalt or nickel is present as cations in order to compensate for the negative charge of the HPA), such Anderson heteropolyanions with formula CoMo₆O₂₄H₆³⁻ and NiMo₆O₂₄H₆⁴⁻ have the advantage of reaching an atomic ratio [(promoter=Co and/or Ni)/Mo] in the range 0.4 to 0.6, i.e. close to or equal to an optimal ratio known to the skilled person and in the range 0.4 to 0.6 in order to maximize the performances of the hydrotreatment catalysts, the Co and/or the Ni taken into account for the calculation of this atomic ratio being the Co and/or the Ni present as counter-ions and heteroelements X of the structure HPA. By way of example, the cobalt or nickel salts of the monomeric 6-molybdocobaltate ion (with formula CoMo₆O₂₄H₆³⁻, 3/2Co²⁺, or CoMo₆O₂₄H₆³⁻, 3/2Ni²⁺) and the cobalt or nickel salts of the dimeric decamolybdocobaltate ion (with formula Co₂Mo₁₀O₃₈H₄⁶⁻, 3Co²⁺ or Co₂Mo₁₀O₃₈H₄⁶⁻, 3Ni²⁺) are characterized by atomic ratios [(promoters=Co and/or Ni)/Mo] of 0.41 and 0.5 respectively. Again by way of example, the cobalt or nickel salts of the monomeric 6-molybdonickellate ion (with formula NiMo₆O₂₄H₆⁴⁻, 2Co²⁺ and NiMo₆O₂₄H₆⁴⁻, 2Ni²⁺) and the cobalt or nickel salts of the dimeric decamolybdonickellate ion (with formula Ni₂Mo₁₀O₃₈H₄⁸⁻, 4Co²⁺ and Ni₂Mo₁₀O₃₈H₄⁸⁻, 4Ni²⁺) are characterized by atomic ratios [(promoters=Co and/or Ni)/Mo] of 0.5 and 0.6 respectively, the Co and/or the Ni taken into account for the calculation of this atomic ratio being the Co and/or the Ni present both as counter-ions and as heteroelements X of the HPA structure. In the case in which the HPA contains cobalt (X=Co) and molybdenum (M=Mo) in its structure, it is preferably dimeric. A mixture of the two forms, monomeric and dimeric, of said HPA may also be used. In the case in which the HPA contains nickel (X=Ni) and molybdenum (M=Mo) in its structure, it is preferably monomeric. A mixture of the two forms, monomeric and dimeric, of said HPA may also be used. Highly preferably, the Anderson HPA used in order to obtain the material in accordance with the invention is a dimeric HPA comprising cobalt and molybdenum within its structure and the counter-ion of the HPA salt may be cobalt CO^{II}₃[CO^{III}₂Mo₁₀O₃₈H₄] or nickel Ni^{II}₃[Co^{III}₂Mo₁₀O₃₈H₄].

A second preferred category of heteropolyanions (second embodiment) advantageously trapped in the mesostructured matrix comprised in each of said spherical particles of the material in accordance with the invention is such that said heteropolyanions have the formula XM₁₂O₄₀Hₕ^{q-} (x=1, m=12, y=40, h=0 to 12, q=3 to 12) and/or the formula XM₁₁O₃₉Hₕ^{q-} (x=l, m=11, y=39, h=0 to 12, q=3 to 12) with H, X, M, O, h, x, m, y and q having the same definitions as those given in general formula (I) above. The heteropolyanions with formula XM₁₂O₄₀Hₕ^{q-} are heteropolyanions having a Keggin structure and the heteropolyanions with formula XM₁₁O₃₉Hₕ^{q-} are heteropolyanions having a lacunary Keggin structure. The heteropolyanions with a Keggin structure are obtained, for a variety of pH ranges, using the production pathways described in the publication by A. Griboval, P. Blanchard, E. Payen, M. Fournier, J. L. Dubois, Chem. Lett., 1997, 12, 1259. Heteropolyanions with a Keggin structure are also known in substituted forms in which a metallic element from group VIII, preferably cobalt or nickel, is substituted for the metal M present in the formula XM₁₂O₄₀Hₕ^{q-}: examples of such substituted Keggin species are the heteropolyanions PNiMo₁₁O₄₀H⁶⁻ or PCoMo₁₁O₄₀H⁶⁻ (one Mo atom substituted with one atom of Ni or one atom of Co respectively). The species PCoMo₁₁O₄₀H⁶⁻ is, for example, prepared in accordance with the protocol described in the publication by L. G. A. van de Water et al. J. Phys. Chem. B, 2005, 109, 14513. Other substituted Keggin species, advantageously trapped in the mesostructured matrix comprised in each of said spherical particles of the material in accordance with the invention, are the species PVMo₁₁O₄₀⁴⁻, PV₂Mo₁₀O₄₀⁵⁻, PV₃Mo₉O₄₀⁶⁻ or PV₄Mo₈O₄₀⁷⁻ (1 or more atoms of V substituting for 1 or more atoms of Mo acting as the element M): these species and their mode of preparation are described in the publication by D. Soogund et al. Appl. Catal. B, 2010, 98, 1, 39. Other substituted Keggin heteropolyanion species are the species PMo₃W₉O₄₀³⁻, PMo₆W₆O₄₀³⁻, PMo₉W₃O₄₀³⁻. Even more substituted Keggin heteropolyanion species and their mode of preparation have been described in the patent application FR 2.764.211: said species have formula Z_{w}XM₁₁O₄₀Z′C_{(z-2w)}. Z is cobalt and/or nickel, X is phosphorus, silicon or boron and M is molybdenum and/or tungsten, Z′ is an atom substituting for an atom of the element M and is selected from cobalt, iron, nickel, copper and zinc, and C is an H⁺ ion or an alkylammonium cation, C acting as a counter-ion, as is Z, w takes the value 0 to 4.5, and z a value between 7 and 9. Examples of heteropolycompounds (heteropolyanions+counter-ions) which are particularly suitable for deploying the material of the invention and having this formula are the species PCoMo₁₁O₄₀H(NH₄)₆, PNiMo₁₁O₄₀H(NH₄)₆, SiCoMo₁₁O₄₀H₂(NH₄)₆, Co₃PCoMo₁₁O₄₀H and Co₃PNiMo₁₁O₄₀H the preparation of which is described in detail in the application FR 2.764.211. The heteropolyanions described in patent application FR 2.764.211 are advantageous because they have an atomic ratio between the element from group VIII and from group VI which may be up to 0.5.

Keggin heteropolyanions with formula XM₁₂O₄₀^{q-} where X is selected from phosphorus, silicon and boron and M is selected from molybdenum and/or tungsten with cobalt and/or nickel as counter-ions have been described in U.S. Pat. No. 2,547,380 and patent application FR 2.749.778. In particular, U.S. Pat. No. 2,547,380 discloses the beneficial use, in hydrotreatment processes, of heteropolyacid salts of metals from group VIII such as cobalt or nickel salts of phosphomolybdic, silicomolybdic, phosphotungstic or silicotungstic acids for hydrotreatment applications. By way of example, nickel phosphotungstate with formula 3/2Ni²⁺, PW₁₂O₄₀³⁻ with a Ni/W ratio of 0.125 and cobalt phosphomolybdate with formula 3/2Co²⁺, PMo₁₂O₄₀³⁻ may be used. A particular preparation method is described in patent application FR 2.749.778 for the specific preparation of the heteropolycompounds Co_{7/2}PMo₁₂O₄₀, Co₄SiMo₁₂O₄₀, Co_{7/2}SiMo₁₂O₄₀ and Co₆PMo₁₂O₄₀, which are particularly suitable for use as metallic particles trapped in the mesostructured matrix comprised in each of the spherical particles of the material in accordance with the invention. The heteropolycompounds disclosed in patent application FR 2.749.778 are of interest, in particular compared with those disclosed in U.S. Pat. No. 2,547,380, because they have higher atomic ratios (element from group VIII/element from group VI) and thus result in better-performing catalysts. This increase in ratio is obtained by reducing the HPA. Hence, at least some of the molybdenum or tungsten present has a valency which is less than its normal value of 6, resulting from the composition, for example, of the phosphomolybdic, phosphotungstic, silicomolybdic or silicotungstic acid.

Heteropolyanions having a lacunary Keggin structure and which are particularly suitable for deploying the material of the invention are described in patent application FR 2.935.139. They have the formula Ni_{a+y/2}XW_{11-y}O_{39-5/2y}, bH₂O in which Ni is nickel, X is selected from phosphorus, silicon and boron, W is tungsten, O is oxygen, y=0 or 2, a=3.5 if X is phosphorus, a=4 if X is silicon, a=4.5 if X is boron and b is a number in the range 0 to 36. Said heteropolyanions have no nickel atoms substituting for a tungsten atom in their structure, said atoms of nickel being placed in the position of a counter-ion in the structure of said heteropolyanion. These heteropolyanion salts are advantageous because of their high solubility. According to the teaching of patent application FR 2.935.139, advantageous heteropolyanions for using the material in accordance with the invention have the formula Ni₄SiW₁₁O₃₉ and Ni_{7/2}PW₁₁O₃₉.

A third preferred category of heteropolyanions (second embodiment) advantageously trapped in the mesostructured matrix comprised in each of said spherical particles of the material in accordance with the invention is such that said heteropolyanions have the formula HₕP₂Mo₅O₂₃^{(6-h)-}, with h=0, 1 or 2. Such heteropolyanions are termed Strandberg heteropolyanions. The preparation of Strandberg HPAs is described in the article by W—C. Cheng et al. J. Catal., 1988, 109, 163. It has since been shown by J. A. Bergwerff, et al., Journal of the American Chemical Society 2004, 126, 44, 14548, that the heteropolyanion H₂P₂Mo₅O₂₃⁴⁻ is of particular advantage for use in hydrotreatment applications.

Advantageously, the elementary spherical particles constituting said inorganic material in accordance with the invention comprise metallic particles in the form of heteropolyanions selected from the first, the second and/or the third category described above. In particular, said metallic particles may be formed from a mixture of HPA with different formulae belonging to the same category or from a mixture of HPAs belonging to different categories. As an example, it is advantageous to use, alone or as a mixture, HPAs of the PW₁₂O₄₀³⁻ type with the Keggin type HPAs PMo₁₂O₄₀³⁻, PCoMo₁₁O₄₀H⁶⁻ and H₂P₂Mo₅O₂₃⁴⁻ which are well known to the skilled person.

The inorganic material in accordance with the invention comprises a content by weight of the element(s) vanadium, niobium, tantalum, molybdenum and tungsten in the range 1 to 40%, expressed as the % by weight of oxide with respect to the mass of the final material in the oxide form, preferably in the range 4% to 35% by weight, preferably in the range 4% to 30% and still more preferably in the range 4% to 20%. The inorganic material in accordance with the invention comprises an overall quantity of metal(s) from group VIII, especially nickel and/or cobalt, in the range 0 to 15%, expressed as the % by weight of oxide with respect to the mass of the final material in the oxide form, preferably in the range 0.5% to 10% by weight and still more preferably in the range 1 to 8% by weight.

The quantity of metallic particles in the form of a polyoxometallates, preferably in the form of heteropolyanions, is such that said particles advantageously represent 2% to 50% by weight, preferably 4% to 40% by weight and highly preferably 6% to 30% by weight of the material of the invention.

In accordance with a first particular embodiment of the material in accordance with the invention, each of the spherical particles constituting said material further comprises zeolitic nanocrystals. Said zeolitic nanocrystals are trapped, with the metallic particles in the form of a polyoxometallate, in the mesostructured matrix contained in each of the elementary spherical particles. In accordance with this embodiment of the invention consisting of trapping zeolitic nanocrystals in the mesostructured matrix, the material of the invention has at the same time, in each of the elementary spherical particles, a mesoporosity in the matrix itself (mesopores with a uniform diameter in the range 1.5 to 50 nm, preferably in the range 1.5 to 30 nm and more preferably in the range 4 to 20 nm) and a zeolitic type microporosity generated by the zeolitic nanocrystals trapped in the mesostructured matrix. Said zeolitic nanocrystals have a pore size in the range 0.2 to 2 nm, preferably in the range 0.2 to 1 nm and more preferably in the range 0.2 to 0.8 nm. Said zeolitic nanocrystals advantageously represent 0.1% to 30% by weight, preferably 0.1% to 20% by weight and highly preferably 0.1% to 10% by weight of the material of the invention. The zeolitic nanocrystals have a maximum dimension, generally a maximum diameter, of 300 nm, and preferably have a dimension, generally a diameter, in the range 10 to 100 nm. Any zeolite, in particular but not in a restrictive manner those listed in the “Atlas of zeolite framework types”, 6^{th} revised Edition, 2007, Ch. Baerlocher, L. B. L. McCusker, D. H. Olson, may be employed in the zeolitic nanocrystals present in each of the elementary spherical particles constituting the material in accordance with the invention. The zeolitic nanocrystals preferably comprise at least one zeolite selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1. Highly preferably, the zeolitic nanocrystals comprise at least one zeolite selected from zeolites with structure type MFI, BEA, FAU and LTA. Nanocrystals of various zeolites and in particular of zeolites with a different structure type may be present in each of the spherical particles constituting the material in accordance with the invention. In particular, each of the spherical particles constituting the material in accordance with the invention may advantageously comprise at least first zeolitic nanocrystals wherein the zeolite is selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1, preferably from zeolites with structure type MFI, BEA, FAU and LTA, and at least second zeolitic nanocrystals wherein the zeolite differs from that of the first zeolitic nanocrystals and is selected from the zeolites IZM-2, ZSM-5, ZSM-12, ZSM-48, ZSM-22, ZSM-23, ZBM-30, EU-2, EU-11, silicalite, beta, zeolite A, faujasite, Y, USY, VUSY, SDUSY, mordenite, NU-10, NU-87, NU-88, NU-86, NU-85, IM-5, IM-12, IM-16, ferrierite and EU-1, preferably from zeolites with structure type MFI, BEA, FAU, and LTA. The zeolitic nanocrystals advantageously comprise at least one zeolite which is either entirely of silica or contains, in addition to silicon, at least one element T selected from aluminium, iron, boron, indium, gallium and germanium, preferably aluminium.

In accordance with a second particular embodiment of the material in accordance with the invention, which may or may not be independent of said first embodiment described above, each of the spherical particles constituting said material further comprises one or more additional element(s) selected from organic agents, metals from group VIII of the periodic classification of the elements and doping species belonging to the list of doping elements constituted by phosphorus, fluorine, silicon and boron and their mixtures. The total quantity of doping species is in the range 0.1% to 10% by weight, preferably in the range 0.5% to 8% by weight, and still more preferably in the range 0.5% to 6% by weight, expressed as the % by weight of oxide, with respect to the weight of mesostructured inorganic material in accordance with the invention.

In accordance with the invention, said elementary spherical particles constituting the material in accordance with the invention have a maximum diameter equal to 200 μm, preferably less than 100 μm, advantageously in the range 50 nm to 50 μm, highly advantageously in the range 50 nm to 30 μm and still more advantageously in the range 50 nm to 10 μm. More precisely, they are present in the material in accordance with the invention in the form of powder, beads, pellets, granules, extrudates (cylinders which may or may not be hollow, multilobed cylinders, for example with 2, 3, 4 or 5 lobes, or twisted cylinders) or rings. The material in accordance with the invention advantageously has a specific surface area in the range 50 to 1100 m²/g, highly advantageously in the range 50 to 600 m²/g and still more preferably in the range 50 to 400 m²/g.

The present invention also pertains to a process for the preparation of the material in accordance with the invention.

Said preparation process in accordance with the invention comprises at least the following steps in succession:

a) mixing in solution:
at least one surfactant;
at least one precursor of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements;
metallic particles in the form of a polyoxometallate with formula (XₓMₘO_{y}Hₕ)^{q-} where H is a hydrogen atom, O is an oxygen atom, X is an element selected from phosphorus, silicon, boron, nickel and cobalt and M is one or more elements selected from vanadium, niobium, tantalum, molybdenum, tungsten, iron, copper, zinc, cobalt and nickel, x being equal to 0, 1, 2 or 4, m being equal to 5, 6, 7, 8, 9, 10, 11, 12 or 18, y being in the range 17 to 72, h being in the range 0 to 12 and q being in the range 1 to 20, or at least one metallic precursor of said metallic particles;
optionally, at least one colloidal solution in which zeolite crystals with a maximum nanometric dimension equal to 300 nm are dispersed;
   b) aerosol atomisation of said solution obtained in step a) in order to result in the formation of spherical liquid droplets; c) drying said droplets; d) eliminating at least said surfactant in order to obtain said mesostructured inorganic material in which the metallic particles are trapped in the form of a polyoxometallate.

Said preparation process in accordance with the invention advantageously comprises, subsequently to said step d), at least one step e) for regenerating polyoxometallate species then at least one step f) for drying the solid obtained in said step e). Said steps e) and f) are carried out when the polyoxometallate species are partially or completely decomposed during step d) of the preparation process of the invention. When said steps e) and f) have been carried out, an inorganic material in accordance with the invention is obtained in which the metallic particles, preferably HPAs, are trapped within each of the mesostructured matrices present in each of the elementary spherical particles constituting the material of the invention.

In accordance with step a) of the process for the preparation of the material of the invention, said metallic particles are either isopolyanions or heteropolyanions, preferably heteropolyanions. They are prepared using synthesis methods which are known to the skilled person or are commercially available.

In general and in a manner which is known to the skilled person, the isopolyanions are formed by reacting oxoanions of the MO₄ⁿ⁻ type (the value of n depending on the nature of M: n is preferably equal to 2 when M=Mo or W and preferably equal to 3 when M=V, Nb, Ta) together, where M is one or more elements selected from vanadium, niobium, tantalum, molybdenum, tungsten, cobalt and nickel. As an example, molybdenum compounds are well known for this type of reaction since, as a function of pH, the molybdenum compound in solution may be present in the MoO₄²⁻ form or in the form of an isopolyanion Mo₇O₂₄⁶⁻ obtained in accordance with the reaction: 7MoO₄²⁻+8H⁺→Mo₇O₂₄⁶⁻+4H₂O. Regarding tungsten-based compounds, potential acidification of the reaction medium may result in the generation of α-metatungstate, condensed 12-fold: 12WO₄²⁻+18H⁺→H₂W₁₂O₄₀⁶⁻+8H₂O. These isopolyanion species, in particular the species Mo₇O₂₄⁶⁻ and H₂W₁₂O₄₀⁶⁻, are advantageously employed as metallic particles for the preparation of the material of the invention. The preparation of isopolyanions is fully described in the work Heteropoly and Isopoly Oxometallates, Pope, Eds. Springer-Verlag, 1983 (chapter II, pages 15 and 16).

In general and in a manner which is known to the skilled person, the heteropolyanions are obtained by polycondensation of oxoanions of the MO₄ⁿ⁻ type (the value of n depending on the nature of M: n is preferably equal to 2 when M=Mo or W and preferably equal to 3 when M=V, Nb, Ta) around one (or more) oxoanion(s) of the type XO₄^{q-}, (the value of q depending on the nature of M, the charge q being dictated by the octet rule and by the nature of X), M being one or more elements selected from vanadium, niobium, tantalum, molybdenum, tungsten, cobalt and nickel and X being an element selected from P, Si, B, Ni and Co. Water molecules are then eliminated and oxo bridges are created between the atoms X and M. These condensation reactions are governed by various experimental factors such as pH, the concentration of the species in solution, the nature of the solvent and the atomic ratio M/X. The preparation of heteropolyanions has been fully described in the work Heteropoly and Isopoly Oxometallates, Pope, Eds. Springer-Verlag, 1983 (chapter II, pages 15 and 16).

Particular heteropolyanion preparation methods which can advantageously be carried out to synthesize the metallic particles used in said step a) of the preparation process of the invention are described in patent applications FR 2.935.139, FR 2.764.211, FR 2.749.778 and FR 2.843.050. Other particular modes for preparing heteropolyanions for use as metallic particles for the preparation of the material of the invention are described in the various publications indicated above in the description of the various categories of HPA.

As an example, when carrying out said step a) of the process of the invention, the metallic particles in the form of a polyoxometallate with formula (I), preferably heteropolyanions, are easily prepared from the multimetallic precursors necessary for obtaining them; they are either dissolved, prior to carrying out said step a) in a solvent before being introduced into said mixture of step a), or are introduced directly into said mixture of step a). In the case in which said multi-metallic precursors are dissolved prior to said step a), the solvent used to dissolve the precursor or precursors is aqueous and the solution obtained after dissolving the metallic precursor(s) prior to step a) containing said precursors is clear and has a neutral or acidic pH, preferably acidic. Said metallic particles, preferably heteropolyanions, may also be used in the solid and isolated form, and be introduced directly into the mixture of said step a) of the preparation process of the invention, or be introduced in solution into an aqueous solvent before being introduced into the mixture of step a).

In accordance with step a) of the process for the preparation of the mesostructured inorganic material in accordance with the invention, the precursor(s) of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium, and a mixture of at least two of these elements, preferably selected from the group constituted by silicon, aluminium, titanium, zirconium, gallium, germanium and cerium and a mixture of at least two of these elements is(are) inorganic oxide precursor(s) which are well known to the skilled person. The precursor(s) of at least said element Y may be any compound comprising the element Y and capable of liberating that element in solution, for example in aquo-organic solution, preferably in aquo-organic acid solution, in a reactive form. In the preferred case in which Y is selected from the group constituted by silicon, aluminium, titanium, zirconium, gallium, germanium and cerium and a mixture of at least two of these elements, the precursor(s) of at least said element Y is(are) advantageously an inorganic salt of said element Y with formula YZₙ, (n=3 or 4), Z being a halogen, the group NO₃ or a perchlorate; preferably, Z is chlorine. The precursor(s) of at least said element Y under consideration may also be (an) alkoxide precursor(s) with formula Y(OR)ₙ where R=ethyl, isopropyl, n-butyl, s-butyl, t-butyl, etc. or a chelated precursor such as Y(C₅H₈O₂)ₙ, with n=3 or 4. The precursor(s) of at least said element Y under consideration may also be (an) oxide(s) or (a) hydroxide(s) of said element Y. Depending on the nature of the element Y, the precursor of the element Y under consideration may also be in the form YOZ₂, Z being a monovalent anion such as a halogen, or the group NO₃. Preferably, said element(s) Y is(are) selected from the group constituted by silicon, aluminium, titanium, zirconium, gallium, germanium and cerium and a mixture of at least two of these elements. Highly preferably, the mesostructured oxide matrix comprises, preferably is constituted by, aluminium oxide, silicon oxide (Y=Si or Al) or comprises, preferably is constituted by, a mixture of silicon oxide and aluminium oxide (Y=Si+Al). In the particular case in which Y is silicon or aluminium or a mixture of silicon and aluminium, the silica and/or alumina precursors used in step a) of the process for the preparation of the material in accordance with the invention are inorganic oxide precursors which are well known to the skilled person. The silica precursor is obtained from any source of silica, advantageously from a sodium silicate precursor with formula Na₂SiO₃, a chlorinated precursor with formula SiCl₄, an alkoxide precursor with formula Si(OR)₄ where R=H, methyl or ethyl, or a chloralkoxide precursor with formula Si(OR)₄₋ₐClₐ where R=H, methyl or ethyl, a being in the range between 0 and 4. The silica precursor may also advantageously be an alkoxide precursor with formula Si(OR)₄₋ₐR′ₐ where R=H, methyl or ethyl and R′ is an alkyl chain or a functionalized alkyl chain, for example functionalized by a thiol, amino, β-diketone or sulphonic acid group, a being in the range between 0 and 4. The alumina precursor is advantageously an inorganic salt of aluminium with formula AlZ₃, Z being a halogen or the group NO₃. Preferably, Z is chlorine. The alumina precursor may also be an alkoxide precursor with formula Al(OR″)₃ where R″=ethyl, isopropyl, n-butyl, s-butyl or t-butyl, or a chelated precursor such as aluminium acetylacetonate (Al(C₅H₇O₂)₃). The alumina precursor may also be an oxide or an aluminium hydroxide.

The surfactant used for the preparation of the mixture in accordance with step a) of the process for the preparation of the material in accordance with the invention is an ionic or non-ionic surfactant or a mixture of the two. Preferably, the ionic surfactant is selected from phosphonium and ammonium ions, and highly preferably from quaternary ammonium salts such as cetyltrimethylammonium bromide (CTAB). Preferably, the non-ionic surfactant may be any copolymer having at least two portions with different polarities, endowing them with amphiphilic macromolecular properties. These copolymers may comprise at least one block forming part of the following non-exhaustive list of polymer families: fluorinated polymers (—[CH₂—CH₂—CH₂—CH₂—O—CO—R1-, in which R1=C₄F₉, C₈F₁₇, etc.), biological polymers such as polyamino acids (poly-lysine, alginates, etc.), dendrimers, polymers constituted by chains of poly(alkylene oxide). In general, any copolymer with an amphiphilic nature which is known to the skilled person may be used (S. Förster, M. Antionnetti, Adv. Mater, 1998, 10, 195-217; S. Förster, T. Plantenberg, Angew. Chem. Int. Ed, 2002, 41, 688-714; H. Cölfen, Macromol. Rapid Commun, 2001, 22, 219-252). Preferably, in the context of the present invention, a block copolymer is used which is constituted by chains of poly(alkylene oxide). Said block copolymer is preferably a block copolymer containing two, three or four blocks, each block being constituted by one chain of poly(alkylene oxide). For a two-block copolymer, one of the blocks is constituted by a chain of poly(alkylene oxide) with a hydrophilic nature and the other block is constituted by a poly(alkylene oxide) chain with a hydrophobic nature. For a three-block copolymer, at least one of the blocks is constituted by a poly(alkylene oxide) chain with a hydrophilic nature, while at least one of the other blocks is constituted by a poly(alkylene oxide) chain with a hydrophobic nature. Preferably, in the case of a three-block copolymer, the poly(alkylene oxide) chains with a hydrophilic nature are chains of poly(ethylene oxide) denoted (PEO)_{w} and (PEO)_{z} and the chains of poly(alkylene oxide) with a hydrophobic nature are chains of poly(propylene oxide) denoted (PPO)_{y}, chains of poly(butylene oxide), or mixed chains wherein each chain is a mixture of several alkylene oxide monomers. Highly preferably, in the case of a three-block copolymer, a compound with formula (PEO)_{w}-(PPO)_{y}-(PEO)_{z} is used, where w is in the range 5 to 300, y is in the range 33 to 300 and z is in the range 5 to 300. Preferably, the values for w and z are identical. Highly advantageously, a compound in which w=20, y=70 and z=20 (P123) is used and a compound in which w=106, y=70 and z=106 (F127) is used. Commercially available non-ionic surfactants with the names Pluronic (BASF), Tetronic (BASF), Triton (Sigma), Tergitol (Union Carbide), Brij (Aldrich) may be used as non-ionic surfactants. For a four-block copolymer, two of the blocks are constituted by a chain of poly(alkylene oxide) with a hydrophilic nature and the other two blocks are constituted by a chain of poly(alkylene oxide) with a hydrophobic nature. Preferably, to prepare the mixture in accordance with step a) of the process for the preparation of the material of the invention, a mixture of an ionic surfactant such as CTAB and a non-ionic surfactant such as P123 or F127 is used.

In step a) of the preparation process in accordance with the invention, the colloidal solution in which the zeolite crystals with a maximum nanometric dimension equal to 300 nm are dispersed, optionally added to the mixture envisaged in said step a), is obtained either by prior synthesis, in the presence of a template, of zeolitic nanocrystals with a maximum nanometric dimension of 300 nm or by using zeolitic crystals which have the ability to disperse in the form of nanocrystals with a maximum nanometric dimension equal to 300 nm in solution, for example in acidic aquo-organic solution. In the first variation consisting of prior synthesis of the zeolitic nanocrystals, these are synthesized using operating protocols which are known to the skilled person. In particular, the synthesis of beta zeolite nanocrystals has been described by T. Bein et al., Micropor. Mesopor. Mater., 2003, 64, 165. The synthesis of nanocrystals of Y zeolite has been described by T. J. Pinnavaia et al., J. Am. Chem. Soc., 2000, 122, 8791. The synthesis of nanocrystals of faujasite zeolite has been described by Kloetstra et al., Microporous Mater., 1996, 6, 287. The synthesis of nanocrystals of ZSM-5 zeolite has been described by R. Mokaya et al., J. Mater. Chem., 2004, 14, 863. The synthesis of nanocrystals of silicalite (or structure type MFI) has been described in a number of publications: R. de Ruiter et al., Synthesis of Microporous Materials, Vol. I; M. L. Occelli, H. E. Robson (eds.), Van Nostrand Reinhold, New York, 1992, 167; A. E. Persson, B. J. Schoeman, J. Sterte, J.-E. Otterstedt, Zeolites, 1995, 15, 611-619. In general, the zeolitic nanocrystals are synthesised by preparing a reaction mixture comprising at least one source of silica, optionally at least one source of at least one element T selected from aluminium, iron, boron, indium, gallium and germanium, preferably at least one source of alumina, and at least one template. The reaction mixture for the synthesis of the zeolitic nanocrystals is either aqueous or aquo-organic, for example a water-alcohol mixture. The reaction mixture is advantageously used under hydrothermal conditions under autogenic pressure, optionally by adding a gas, for example nitrogen, at a temperature in the range 50° C. to 200° C., preferably in the range 60° C. to 170° C. and more preferably at a temperature which does not exceed 120° C. until the zeolitic nanocrystals are formed. At the end of said hydrothermal treatment, a colloidal solution is obtained in which the nanocrystals are in the dispersed state. The template may be ionic or neutral, depending on the zeolite to be synthesized. It is usual to use templates from the following non-exhaustive list: nitrogen-containing organic cations, elements from the alkali family (Cs, K, Na, etc.), crown ethers, diamines as well as any other template which is well known to the skilled person. In the second variation consisting of using zeolitic crystals directly, these are synthesised by methods which are known to the skilled person. Said zeolitic crystals may already be in the form of nanocrystals. In addition, zeolitic crystals with a dimension of more than 300 nm, for example in the range 300 nm to 200 μm, may advantageously be used; they disperse in solution, for example in an aquo-organic solution, preferably in acidic aquo-organic solution, in the form of nanocrystals with a maximum nanometric dimension of 300 nm. Obtaining zeolitic crystals which disperse in the form of nanocrystals with a maximum nanometeric dimension of 300 nm is also possible by functionalizing the surface of the nanocrystals. The zeolitic crystals used are either in their as-synthesized form, i.e. still containing template, or in their calcined form, i.e. free of said template. When the zeolitic crystals used are in their as synthesized form, said template is eliminated during step d) of the preparation process of the invention.

The solution in which at least one surfactant, at least said metallic particles in the form of a polyoxometallate, at least one precursor of at least one element Y and optionally at least one stable colloidal solution in which zeolite crystals with a maximum nanometeric dimension of 300 nm are dispersed are mixed in accordance with step a) of the process for the preparation of the material of the invention may be acidic or neutral. Preferably, said solution is acidic and has a maximum pH of 5, preferably in the range 0 to 4. Non-exhaustive examples of acids which may be used to obtain an acidic solution are hydrochloric acid, sulphuric acid and nitric acid. Said solution in accordance with said step a) may be aqueous or it may be a water-organic solvent mixture, the organic solvent preferably being a polar solvent which is miscible with water, in particular an alcohol, preferably ethanol. Said solution in accordance with said step a) of the preparation process of the invention may also be practically organic, preferably practically alcoholic, the quantity of water being such that hydrolysis of the inorganic precursors is ensured (stoichiometric quantity). Highly preferably, said solution in said step a) of the preparation process of the invention in which at least one surfactant, at least said metallic particles in the form of a polyoxometallate, at least one precursor of at least said element Y and optionally at least one stable colloidal solution in which zeolite crystals with a maximum nanometeric dimension of 300 nm are dispersed are mixed is an acidic aquo-organic mixture, highly preferably a water-alcohol acidic mixture.

The quantity of zeolitic nanocrystals dispersed in the colloidal solution, obtained in accordance with this variation by prior synthesis, in the presence of a template, of zeolitic nanocrystals with a maximum nanometeric dimension of 300 nm or in the variation using zeolitic crystals which have the property of dispersing in the form of nanocrystals with a maximum nanometeric dimension of 300 nm in solution, for example in acidic aquo-organic solution, optionally introduced during step a) of the preparation process of the invention, is such that the zeolitic nanocrystals advantageously represent 0.1% to 30% by weight, preferably 0.1% to 20% by weight and highly preferably 0.1% to 10% by weight of the material of the invention.

The quantity of metallic particles in the form of a polyoxometallates is such that said particles advantageously represent 4% to 50% by weight, preferably 5% to 40% by weight and more preferably 6% to 30% by weight of the material of the invention.

The initial concentration of surfactant introduced into the mixture in accordance with said step a) of the preparation process of the invention is defined by c₀, and c₀ is defined with respect to the critical micellar concentration (c_{mc}) which is familiar to the skilled person. The c_{mc} is the limiting concentration beyond which self-assembly of molecules of surfactant occurs in the solution. The concentration c₀ may be lower than, equal to or higher than c_{mc}; preferably, it is lower than the c_{mc}. In a preferred implementation of the process for the preparation of the material of the invention, the concentration c₀ is less than c_{mc} and said solution envisaged in step a) of said preparation process of the invention is an acidic water-alcohol mixture. In the case in which the solution envisaged in step a) of the preparation process of the invention is a water-organic solvent mixture, preferably acidic, during said step a) of the preparation process of the invention, the concentration of surfactant at the origin of the mesostructuring of the matrix should preferably be lower than the critical micellar concentration so that evaporation of said aquo-organic solution, preferably acidic, during step b) of the preparation process of the invention by the aerosol technique causes a phenomenon of micellization or self-assembly, resulting in mesostructuring of the matrix of the material of the invention around said metallic particles in the form of a polyoxometallates and optional zeolitic nanocrystals which themselves remain unchanged in their shape and dimensions during steps b) and c) of the preparation process of the invention. When c₀<c_{mc}, mesostructuring of the matrix of the material of the invention prepared using the process described above is consecutive to a gradual concentration, in each droplet, of at least the precursor of said element Y and the surfactant, up to a concentration of surfactant of c>c_{mc} resulting from evaporation of the aquo-organic solution, preferably acidic.

In general, the increase in the joint concentration of at least one precursor of said hydrolyzed element Y and the surfactant causes precipitation of at least said hydrolyzed precursor of said element Y around the self-organized surfactant and as a consequence, structuring of the matrix of the material of the invention. The inorganic/inorganic, organic/organic and organic/inorganic phase interactions result, via a cooperative self-assembly mechanism, in condensation of at least said precursor of said hydrolyzed element Y about the self-organized surfactant. During this self-assembly phenomenon, said metallic particles in the form of a polyoxometallate and optional zeolitic nanocrystals become trapped in said mesostructured matrix based on an oxide of at least said element Y included in each of the elementary spherical particles constituting the material of the invention.

The aerosol technique is particularly advantageous for carrying out said step b) of the preparation process of the invention so as to constrain the reagents present in the initial solution to interact together; loss of material apart from solvents, i.e. the solution, preferably the aqueous solution, preferably acidic, and optionally supplemented with a polar solvent, is not possible, and so the totality of said element(s) Y, said metallic particles in the form of a polyoxometallate and optional zeolitic nanocrystals initially present are completely conserved throughout the preparation process of the invention, instead of potentially being eliminated during filtration and washing steps encountered in conventional synthesis processes which are known to the skilled person.

The atomization step of the solution of said step b) of the preparation process of the invention produces spherical droplets. The size distribution of these droplets is of the log normal type. The aerosol generator used in the context of the present invention is a commercial model 9306A apparatus provided by TSI which has a 6-jet atomizer. Atomization of the solution is carried out in a chamber into which a vector gas, preferably a O₂/N₂ mixture (dry air), is fed at a pressure P equal to 1.5 bars. The diameter of the droplets varies as a function of the aerosol apparatus employed. In general, the diameter of the droplets is in the range 150 nm to 600 μm.

In accordance with step c) of the preparation process of the invention, said droplets are then dried. Drying is carried out by transporting said droplets via the vector gas, preferably the O₂/N₂ mixture, in PVC tubes, which results in gradual evaporation of the solution, for example the acidic aquo-organic solution obtained during said step a), and thus to the production of elementary spherical particles. Said drying is completed by passing said particles into an oven the temperature of which can be adjusted, the normal temperature range being from 50° C. to 600° C., preferably 80° C. to 400° C., the residence time for these particles in the oven being of the order of one second. The particles are then collected on a filter. A pump placed at the end of the circuit encourages the species to be channelled into the experimental aerosol device. Drying the droplets in step c) of the preparation process of the invention is advantageously followed by passage through the oven at a temperature in the range 50° C. to 150° C. Elimination of the surfactant introduced in said step a) of the preparation process of the invention and optionally of the template used to synthesise said zeolitic nanocrystals in accordance with step d) of the preparation process of the invention in order to obtain the mesostructured material of the invention is advantageously carried out by heat treatment, preferably by calcining in air (optionally enriched in O₂) in a temperature range of 300° C. to 1000° C., more precisely in a range of 500° C. to 600° C. for a period of 1 to 24 hours, preferably for a period of 3 to 15 hours.

After carrying out said step d), the preparation process of the invention advantageously comprises a step d) consisting of regenerating said metallic particles in the form of a polyoxometallate which may have decomposed during step d). Said regeneration step e) is preferably carried out by washing the solid obtained from said step d) with a polar solvent using a Soxhlet extractor. The function of this type of extractor is well known to the skilled person. Preferably, the extraction solvent is an alcohol, acetonitrile, or water, preferably an alcohol and highly preferably methanol. Said step e) is carried out for a period of 1 to 24 hours, preferably 1 to 8 hours. Said regeneration step e) is carried out when said metallic particles in the form of a polyoxometallate are decomposed during said step d). The decomposition of said metallic particles is demonstrated by Raman spectroscopy which can be used to detect the presence or absence of said metallic particles in the form of polyoxometallates, preferably in the form of heteropolyanions, as a function of the bands appearing in the Raman spectrum. The decomposition of said metallic particles after carrying out said step d) may be partial or complete. Said step e) is a step for partial or complete regeneration of said metallic particles.

Said step e) is followed by a drying step 0 which is advantageously carried out at a temperature in the range 40° C. to 100° C. and highly advantageously in the range 40° C. to 85° C. Said step 0 is carried out for a period in the range 12 to 48 hours. Said step 0 is preferably only carried out when the preparation process of the invention includes carrying out said step e).

In accordance with a first particular implementation of the process for the preparation of the material of the invention, at least one sulphur-containing compound is introduced into the mixture of said step a) or during the course of said step d) or during the course of said step e) in order to obtain the mesostructured inorganic material of the invention, at least in part but not completely in the sulphide form. Said sulphur-containing compound is selected from compounds containing at least one sulphur atom which will decompose at low temperatures (80-90° C.) to cause the formation of H₂S. As an example, said sulphur-containing compound is thiourea or thioacetamide. In accordance with said first particular implementation, sulphurization of said material of the invention is partial such that the presence of sulphur in said mesostructured inorganic material does not totally affect the presence of said metallic particles in the form of polyoxometallate. After sulphurization, the particles in the form of a polyoxometallates preferably in the form of heteropolyanions represent 2% to 50% by weight, preferably 4% to 40% by weight and highly preferably 6% to 30% by weight of the material of the invention.

The mesostructured inorganic material of the invention constituted by elementary spherical particles comprising metallic particles in the form of a polyoxometallate trapped in a mesostructured matrix based on an oxide of at least one element Y may be formed into the form of a powder, beads, pellets, granules, extrudates (cylinders which may or may not be hollow, multilobed cylinders with 2, 3, 4 or 5 lobes for example, twisted cylinders), or rings, etc., these shaping operations being carried out using conventional techniques which are known to the skilled person. Preferably, the material of the invention is obtained in the form of a powder, which is constituted by elementary spherical particles with a maximum diameter of 200 μm.

The operation for shaping the mesostructured inorganic material of the invention consists of mixing said mesostructured material with at least one porous oxide material which acts as a binder. Said porous oxide material is preferably a porous oxide material selected from the group formed by alumina, silica, silica-alumina, magnesia, clays, titanium oxide, zirconium oxide, lanthanum oxide, cerium oxide, aluminium phosphates, boron phosphates and a mixture of at least two of the oxides cited above. Said porous oxide material may also be selected from alumina-boron oxide, alumina-titanium oxide, alumina-zirconia and titanium oxide-zirconia mixtures. The aluminates, for example magnesium, calcium, barium, manganese, iron, cobalt, nickel, copper or zinc aluminates, as well as mixed aluminates, for example those containing at least two of the metals cited above, are advantageously used as the porous oxide material. It is also possible to use titanates, for example zinc, nickel, or cobalt titanates. It is also advantageously possible to use mixtures of alumina and silica and mixtures of alumina with other compounds such as elements from group VIB, phosphorus, fluorine or boron. It is also possible to use simple, synthetic or natural clays of the dioctahedral 2:1 phyllosilicate or trioctahedral 3:1 phyllosilicate type such as kaolinite, antigorite, chrysotile, montmorillonite, beidellite, vermiculite, talc, hectorite, saponite or laponite. These clays may optionally be delaminated. Advantageously, it is also possible to use mixtures of alumina and clay and mixtures of silica-alumina and clay. Similarly, using at least one compound as a binder selected from the group formed by the molecular sieve family of the crystalline aluminosilicate type and synthetic and natural zeolites such as Y zeolite, fluorinated Y zeolite, Y zeolite containing rare earths, X zeolite, L zeolite, beta zeolite, small pore mordenite, large pore mordenite, omega zeolites, NU-10, ZSM-22, NU-86, NU-87, NU-88, and ZSM-5 zeolite, may be envisaged. Of the zeolites, it is usually preferable to use zeolites with a framework silicon/aluminium (Si/Al) atomic ratio which is greater than approximately 3/1. Advantageously, zeolites with a faujasite structure are used, in particular stabilized and ultrastabilized (USY) Y zeolites either in the at least partially exchanged form with metallic cations, for example alkaline-earth metal cations and/or cations of rare earth metals with an atomic number of 57 to 71 inclusive, or in the hydrogen form (Atlas of zeolite framework types, 6^{th} revised Edition, 2007, Ch. Baerlocher, L. B. McCusker, D. H. Olson). Finally, it is possible to use, as the porous oxide material, at least one compound selected from the group formed by the family of non-crystalline aluminosilicate type molecular sieves such as mesosporous silicas, silicalite, silicoaluminophosphates, aluminophosphates, ferrosilicates, titanium silicoaluminates, borosilicates, chromosilicates and aluminophosphates of transition metals (including cobalt). The various mixtures using at least two of the compounds cited above are also suitable for use as a binder.

In a second particular implementation of the process for the preparation of the material of the invention, which may or may not be independent of said first implementation, one or more additional element(s) may be introduced into the mixture of said step a) of the preparation process of the invention, and/or by impregnation of the material obtained from said step d) with a solution containing at least said additional element and/or by impregnation of material obtained from said step f) with a solution containing at least said additional element and/or by impregnation of the mesostructured material of the invention, which has already been shaped, with a solution containing at least said additional element. Said additional element is selected from metals from group VIII of the periodic classification of the elements, organic agents and doping species belonging to the list of doping elements constituted by phosphorus, fluorine, silicon and boron. In accordance with said second particular implementation, one or more additional element(s) as defined above is(are) introduced during the course of the process for the preparation of the material of the invention in one or more steps. In the case in which said additional element is introduced by impregnation, the dry impregnation method is preferred. Each impregnation step is advantageously followed by a drying step, for example carried out at a temperature in the range 90° C. to 200° C., said drying step preferably being followed by a step for calcining in air, optionally enriched in oxygen, for example carried out at a temperature in the range 200° C. to 600° C., preferably in the range 300° C. to 500° C., for a period in the range 1 to 12 hours, preferably in the range 2 to 6 hours. The techniques for impregnation, in particular dry impregnation, of a solid material with a liquid solution are well known to the skilled person. The doping species selected from phosphorus, fluorine, silicon and boron do not have any catalytic nature per se, but can be used to increase the catalytic activity of the metal(s) present in said metallic particles, in particular when the material is in the sulphurized form.

The sources of metals from group VIII used as precursors for said additional element based on at least one metal from group VIII are well known to the skilled person. Of the metals from group VIII, cobalt and nickel are preferred. As an example, nitrates will be used such as cobalt nitrate or nickel nitrate, sulphates, hydroxides such as cobalt hydroxides or nickel hydroxides, phosphates, halides (for example chlorides, bromides or fluorides) or carboxylates (for example acetates and carbonates).

The source of boron used as a precursor for said doping species based on boron is preferably selected from acids containing boron, for example orthoboric acid H₃BO₃, ammonium biborate, ammonium pentaborate, boron oxide and boric esters. Boron may also be introduced at the same time as one or more of the elements M selected from the list given above (M=vanadium, niobium, tantalum, molybdenum, tungsten, iron, copper, zinc, cobalt and/or nickel) in the form of heteropolyanions (X=boron in the formula XₓMₘO_{y}Hₕ^{q-}), in particular Keggin, lacunary Keggin, or substituted Keggin heteropolyanions. The following heteropolyanions in particular may be cited: boromolybdic acid and its salts, and borotungstic acid and its salts. The source of boron in the form of heteropolyanions is then introduced during step a) of the preparation process of the invention. In the case in which the source of boron is introduced by impregnation, said step for impregnation with the boron source is carried out using, for example, a solution of boric acid in a water/alcohol mixture or in a water/ethanolamine mixture. The source of boron may also be impregnated using a mixture formed by boric acid, hydrogen peroxide and a basic organic compound containing nitrogen, such as ammonia, primary and secondary amines, cyclic amines, compounds of the pyridine and quinolines family or compounds of the pyrrole family.

The source of phosphorus used as a precursor for said doping species based on phosphorus is preferably selected from orthophosphoric acid H₃PO₄, and its salts and esters such as ammonium phosphates. The phosphorus may also be introduced at the same time as one or more of the elements M selected from the list given above (M=vanadium, niobium, tantalum, molybdenum, tungsten, iron, copper, zinc, cobalt and/or nickel) in the form of heteropolyanions (X=P in the formula XₓMₘO_{y}Hₕ^{q-}), in the form of heteropolyanions, in particular Keggin, lacunary Keggin or substituted Keggin heteropolyanions or heteropolyanions of the Strandberg type. The following heteropolyanions in particular may be cited: phosphomolybdic acid and its salts, phosphotungstic acid and its salts. The source of phosphorus in the form of heteropolyanions is then introduced during step a) of the preparation process of the invention. In the case in which the phosphorus source is introduced by impregnation, said step for impregnation with the phosphorus source is carried out using, for example, a mixture formed by phosphoric acid and a basic organic compound containing nitrogen such as ammonia, primary and secondary amines, cyclic amines, compounds from the pyridine and quinoline family or compounds from the pyrrole family.

Many sources of silicon may be employed as precursors of said doping species based on silicon. Thus, it is possible to use ethyl orthosilicate Si(OEt)₄, siloxanes, polysiloxanes, silicones, silicone emulsions, or halosilicates such as ammonium fluorosilicate (NH₄)₂SiF₆ or sodium fluorosilicate Na₂SiF₆. Silicon may also be introduced at the same time as one or more of the elements M selected from the list given above (M=vanadium, niobium, tantalum, molybdenum, tungsten, iron, copper, zinc, cobalt and/or nickel) in the form of heteropolyanions (X=Si in the formula XₓMₘO_{y}Hₕ^{q-}), in the form of heteropolyanions, in particular Keggin, lacunary Keggin or substituted Keggin heteropolyanions. The following heteropolyanions in particular may be cited: silicomolybdic acid and its salts, the silicotungstic acid and its salts. The source of silicon in the form of heteropolyanions is then introduced during step a) of the preparation process of the invention. In the case in which the source of silicon is introduced by impregnation, said impregnation step carried out with the source of silicon is carried out using, for example, a solution of ethyl silicate in a water/alcohol mixture. The source of silicon may also be impregnated using a compound of silicon of the silicone type or silicic acid in suspension in water.

The sources of fluorine used as precursors for said doping species based on fluorine are well known to the skilled person. As an example, the fluoride anions may be introduced in the form of hydrofluoric acid or its salts. These salts are formed with alkali metals, ammonium or an organic compound. They are, for example, introduced during step a) of the process for the preparation of the material of the invention. In the case in which the source of fluorine is introduced by impregnation, said step for impregnation with the source of fluorine is carried out using, for example, an aqueous solution of hydrofluoric acid or ammonium fluoride or ammonium bifluoride.

The distribution and localisation of said doping species selected from boron, fluorine, silicon and phosphorus are advantageously determined using techniques such as the Castaing microprobe (distribution profile for the various elements), transmission electron microscopy coupled with X-ray analysis (i.e. EXD analysis which can be used to ascertain the qualitative and/or quantitative elemental composition of a sample from a measurement, using a Si(Li) diode, of the energies of X-ray photons emitted by the region of the sample bombarded by the electron beam) of the elements present in the mesostructured inorganic material of the invention, or by establishing a distribution map of the elements present in said material by electron microprobe. These techniques can be used to demonstrate the presence of these doping species. The analysis of the metals from group VIII and that of the organic species as the additional element are generally carried out by X-ray fluorescence elemental analysis.

Said doping species belonging to the list of doping elements constituted by phosphorus, fluorine, silicon, boron and a mixture of these elements is introduced in a quantity such that the total quantity of doping species is in the range 0.1% to 10% by weight, preferably in the range 0.5% to 8% by weight, and more preferably in the range 0.5% to 6% by weight, expressed as the % by weight of oxide, with respect to the weight of the mesostructured inorganic material of the invention. This is a total content, i.e. it takes into account the presence of the element constituting the doping species both as the element X in the polyoxometallate particles and as the doping species. This is in particular the case for the elements P, Si and B. The atomic ratio between the doping species and the metal(s) M preferably selected from V, Nb, Ta, Mo and W is preferably in the range 0.05 to 0.9, still more preferably in the range 0.08 to 0.8, the doping species and the metal(s) M preferably selected from V, Nb, Ta, Mo and W taken into account for the calculation of this ratio corresponding to the total quantity, in the material of the invention, of doping species and of metal(s) M preferably selected from V, Nb, Ta, Mo and W independently of the mode of introduction.

The organic agents used as precursors of said additional element based on at least one organic agent are selected from organic agents which may or may not have chelating properties or reducing properties. Examples of said organic agents are mono-, di- or polyalcohols, which may be etherified, carboxylic acids, sugars, non-cyclic mono-, di- or polysaccharides such as glucose, fructose, maltose, lactose or sucrose, esters, ethers, crown ethers, compounds containing sulphur or nitrogen, such as nitriloacetic acid, ethylenediaminetetraacetic acid, or diethylenetriamine.

The mesostructured inorganic material in accordance with the invention constituted by elementary spherical particles comprising metallic particles in the form of polyoxometallates, trapped in a mesostructured oxide matrix, having a porosity which is organized and uniform in the mesoporous domain, is characterized by a number of analytical techniques, in particular by small angle X-ray diffraction (small angle XRD), wide angle X-ray diffraction (XRD), nitrogen volumetric analysis (BET), transmission electron microscopy (TEM), scanning electron microscopy (SEM), and X-ray fluorescence (XRF). The presence of polyoxometallates, in particular heteropolyanions, is demonstrated by various techniques, in particular by Raman, UV-visible or infrared spectroscopy, as well as by microanalysis. Techniques such as nuclear magnetic resonance (NMR) or paramagnetic electron resonance (PER) (in particular for reduced HPAs for which a portion of the atoms has a reduced degree of oxidation compared with the initial degree of oxidation) could also be used, depending on the HPAs employed.

The small angle X-ray diffraction technique (values for the angle 28 in the range 0.5° to 5°) can be used to characterize the periodicity on a nanometeric scale generated by the organized mesoporosity of the mesostructured matrix of the material of the invention. In the following discussion, the X-ray analysis is carried out on a powder with a diffractometer operating in reflection mode and provided with a back monochromator using the copper radiation line (wavelength 1.5406 Å). The peaks normally observed on the diffractograms corresponding to a given value of the angle 28 are associated with the lattice spacings d₍ₕₖₗ₎ which are characteristic of the structural symmetry of the material ((hkl) being the Miller indices of the reciprocal lattice) by Bragg's law: 2 d₍ₕₖₗ₎*sin(θ)=n*λ. This indexation then allows the lattice parameters (abc) of the direct lattice to be determined, the value of these parameters being a function of the hexagonal, cubic or vermicular structure obtained. By way of example, the small angle X-ray diffraction diffractogram of a mesostructured material of the invention constituted by elementary spherical particles comprising a mesostructured oxide matrix based on silicon and aluminium obtained using the preparation process of the invention via the use of a quaternary ammonium salt which is cetyltrimethylammonium bromide CH₃(CH₂)₁₅N(CH₃)₃Br (CTAB) has a correlation peak which is completely resolved, corresponding to the correlation distance d between the pores which is characteristic of a vermicular structure and defined by Bragg's law: 2 d₍ₕₖₗ₎*sin(θ)=n*λ.

The wide angle X-ray diffraction technique (values for the angle 2θ in the range 6° to 100°) can be used to characterize a crystalline solid defined by repetition of a unit cell or elementary lattice on a molecular scale. It follows the same physical principle as that governing the small angle X-ray diffraction technique. Thus, the wide angle XRD technique is used to analyze the materials of the invention because it is particularly suited to the structural characterization of the zeolitic nanocrystals which may be present in each of the elementary spherical particles constituting the material defined in accordance with the invention. In particular, it can be used to determine the size of the pores in these zeolitic nanocrystals. As an example, during any occlusion of ZSM-5 type (MFI) zircon nanocrystals, the associated wide angle diffractogram has peaks attributed to the space group Pnma (N° 62) of the ZSM-5 zeolite. The value of the angle obtained on the X-ray diffractogram provides access to the correlation distance d using Bragg's law: 2d₍ₕₖₗ₎*sin(θ)=n*λ.

Nitrogen volumetric analysis, corresponding to the physical adsorption of nitrogen molecules in the pores of the material via a gradual increase in the pressure at constant temperature, provides information on the textural characteristics (pore diameter, pore volume, specific surface area) peculiar to the material of the invention. In particular, it provides access to the specific surface area and to the mesopore distribution of the material. The term “specific surface area” means the BET specific surface area (S_{BET} in m²/g) determined by nitrogen adsorption in accordance with ASTM standard D 3663-78 derived from the BRUNAUER-EMMETT-TELLER method described in the periodical “The Journal of the American Chemical Society”, 1938, 60, 309. The pore distribution which is representative of a population of mesopores centred on a range of 2 to 50 nm (IUPAC classification) is determined from the Barrett-Joyner-Halenda model (BJH). The nitrogen adsorption-desorption isotherm in accordance with the BJH model which is obtained is described in the periodical “The Journal of the American Society”, 1951, 73, 373, written by E. P. Barrett, L. G. Joyner and P. P. Halenda. In the discussion below, the diameter φ of the mesopores of the mesostructured matrix corresponds to the mean nitrogen adsorption diameter defined as being a diameter such that all of the pores with a smaller diameter constitute 50% of the pore volume (Vp) measured on the adsorption branch of the nitrogen isotherm. In addition, the shape of the nitrogen adsorption isotherm and of the hysteresis loop can provide information on the nature of the mesoporosity and on the possible presence of microporosity essentially linked to zeolitic nanocrystals when they are present in the mesostructured oxide matrix. As an example, the nitrogen adsorption isotherm relating to a mesostructured material of the invention obtained using the preparation process of the invention and constituted by elementary spherical particles comprising a mesostructured oxide matrix based on aluminium and silicon prepared using a quaternary ammonium salt, cetyltrimethylammonium bromide CH₃(CH₂)₁₅N(CH₃)₃Br (CTAB), is characterized by a class IVc adsorption isotherm (IUPAC classification) with the presence of an adsorption step for values of P/P0 (where P0 is the saturated vapour pressure at the temperature T) in the range 0.2 to 0.3 associated with the presence of pores of the order of 2 to 3 nm, as confirmed by the associated pore distribution curve.

Concerning the mesostructured matrix, the difference between the value for the pore diameter φ and the lattice parameter defined by small angle XRD as described above can be used to provide a quantity e, where e=a−φ, which is characteristic of the thickness of the amorphous walls of the mesostructured matrix included in each of the spherical particles of the material of the invention. Said lattice parameter a is linked to the correlation distance d between pores by a geometric factor which is characteristic of the geometry of the phase. As an example, in the case of a vermicular structure, e=d−φ.

Transmission electron microscopy (TEM) is also a technique which is widely used to characterize the structure of these materials. It can be used to form an image of the solid being studied, the contrasts observed being characteristics of the structural organization, the texture or the morphology of the particles observed; the maximum resolution of the technique is 1 nm. In the discussion below, the TEM photos will be produced from microtome sections of the sample in order to view a section of an elementary spherical particle of the material of the invention. As an example, the TEM images obtained for a material of the invention constituted by elementary spherical particles comprising metallic particles trapped in a mesostructured matrix based on silicon and aluminium oxide which has been prepared using a quaternary ammonium salt which is cetyltrimethylammonium bromide CH₃(CH₂)₁₅N(CH₃)₃Br (CTAB) have a vermicular structure within a single spherical particle (the material being defined by the dark zones) within which opaque objects might also be seen which represent the zeolitic nanocrystals trapped in the mesostructured matrix. Image analysis can also be used to provide access to the parameters d, φ and e, which are characteristic of the mesostructured matrix defined above.

The morphology and the size distribution of the elementary particles were established by analysis of the photos obtained by scanning electron microscopy (SEM).

The mesostructure of the material in accordance with the invention may be vermicular, cubic or hexagonal, depending on the nature of the surfactant selected as a template.

The metallic particles in the form of a polyoxometallates, more preferably in the form of heteropolyanions (HPA), are in particular characterized by Raman spectroscopy. The Raman spectra were obtained with a dispersive type Raman spectrometer equipped with a laser with an excitation wavelength of 532 nm. The laser beam was focussed on the sample using a microscope provided with a×50 long working distance objective. The power of the laser at the sample was of the order of 1 mW. The Raman signal emitted by the sample was collected by the same objective and dispersed using a 1800 line/mm grating then collected by a CCD (Charge Coupled Device) detector. The spectral resolution obtained was of the order of 2 cm⁻¹. The spectral zone recorded was between 300 and 1500 cm⁻¹. The acquisition period was fixed at 120 s for each Raman spectrum recorded.

Nuclear magnetic resonance (NMR) was also advantageously used to characterize the polyoxometallates, in particular HPAs. ³¹P and ²⁹Si NMR analyses recorded on 300 or 400 MHz spectrometers can be cited in particular.

The present invention also concerns a process for the transformation of a hydrocarbon feed comprising 1) bringing a mesostructured inorganic material in accordance with the invention into contact with a feed comprising at least one sulphur-containing compound, then 2) bringing said material obtained from said step 1) into contact with said hydrocarbon feed.

At the end of said step 1) of the transformation process of the invention, said mesostructured inorganic material is bifunctional, i.e. it has both a hydrodehydrogenating function provided by the presence of a metallic sulphide phase obtained from the polyoxometallates, preferably heteropolyanions, and an acidic function. The acid function is provided by the intrinsic acidic properties of said mesostructured matrix based on an oxide of at least said element Y and in which zeolite nanocrystals are advantageously trapped. The acidity of the mesostructured matrix is generated when the material of the invention comprises, for example, an acidic mesostructured oxide matrix with optional trapped nanocrystals of zeolites which are themselves acids or otherwise, or a non-acidic mesostructured oxide matrix with trapped nanocrystals of zeolites which are themselves acidic. An acid mesostructured oxide matrix advantageously comprises aluminium, titanium, germanium and/or tin as the element Y.

In accordance with said step 1) of the transformation process of the invention, the metallic particles in the form of a polyoxometallates, preferably in the form of heteropolyanions trapped in the mesostructured matrix of each of the spherical particles constituting the inorganic material of the invention, are sulphurized. The transformation of metallic particles in the form of a polyoxometallates, preferably in the form of HPAs, into their associated sulphurized active phase is carried out after heat treatment of said inorganic material of the invention in contact with hydrogen sulphide at a temperature in the range 200° C. to 600° C., more preferably in the range 300° C. to 500° C., using processes which are well known to the skilled person. More precisely, said sulphurization step 1) of the transformation process of the invention is carried out either directly in the reaction unit of said transformation process using a sulphur-containing feed in the presence of hydrogen and hydrogen sulphide (H₂S) introduced as is or obtained from the decomposition of an organic sulphur-containing compound (in situ sulphurization) or prior to charging said material of the invention into the reaction unit for said transformation process (ex situ sulphurization). In the case of ex situ sulphurization, gaseous mixtures such as H₂/H₂S or N₂/H₂S are advantageously used to carry out said step 1). Said material of the invention may also be sulphurized ex situ in accordance with said step 1) from molecules in the liquid phase, the sulphurizing agent then being selected from the following compounds: dimethyldisulphide (DMDS), dimethylsulphide, n-butylmercaptan, polysulphide compounds of the tertiononylpolysulphide type (for example TPS-37 or TPS-54 supplied by ATOFINA), these being diluted in an organic matrix composed of aromatic or alkyl molecules. Said sulphurization step 1) is preferably preceded by a step for heat treatment of said inorganic material of the invention using methods which are well known to the skilled person, preferably by calcining in air in a temperature range in the range 300° C. to 1000° C., and more precisely in the range 500° C. to 600° C., for a period of 1 to 24 hours, preferably for a period of 6 to 15 hours.

In accordance with the invention, said hydrocarbon feed which undergoes the transformation process consisting essentially of the invention comprises molecules containing at least hydrogen and carbon atoms in an amount such that said atoms represent at least 80% by weight, preferably at least 85% by weight of said feed. Said molecules advantageously comprise heteroelements, in particular nitrogen, oxygen and/or sulphur, in addition to the hydrogen atoms and carbon atoms.

In a first particular implementation of the transformation process of the invention, the process for the transformation of hydrocarbon feeds of the invention is a process for hydrodesulphurization of a gasoline cut carried out in the presence of a catalyst the mesostructured material in accordance with the invention of which is a precursor, said material undergoing said sulphurization step i) so that it can fulfil its role as a catalyst.

Said hydrodesulphurization process, which is the subject matter of said first particular implementation of the transformation process of the invention, essentially consists of eliminating the sulphur-containing compounds present in said gasoline cut in order to comply with environmental regulations which are in force (permitted sulphur content up to 10 ppm since 2009). Said gasoline cut has a sulphur content in the range 200 to 5000 ppm by weight, preferably in the range 500 to 2000 ppm by weight. Said gasoline cuts, particularly gasolines from catalytic cracking, contain a non-negligible fraction of branched olefins and therefore constitute a good base for quality gasolines (high research octane number, RON). However, they also contain diolefinic compounds, which are a source of deactivation of the catalysts used in the hydrodesulphurization processes due to the formation of gums. One of the challenges linked to this hydrodesulphurization process, then, consists of selectively hydrogenating the diolefins in a first step and in a second step of hydrodesulphurizing the gasoline cut while keeping the proportion of olefins high. An optimal reaction selectivity is sought, the selectivity being defined as the ratio between the catalytic activity in hydrodesulphurization and the catalytic activity in hydrogenation.

Said mesostructured material of the invention used, after sulphurization, as a catalyst in the hydrodesulphurization process of the invention results in highly satisfactory catalytic performances, in particular in terms of selectivity. It allows intense hydrodesulphurization of a gasoline cut, in particular a gasoline cut obtained from a catalytic cracking unit with a high selectivity and a reduced hydrogen consumption.

Preferably, the material of the invention used, after sulphurization, as a catalyst for carrying out said hydrodesulphurization process has a composition such that said metallic particles trapped in each of said mesostructured matrices are in the form of heteropolyanions, in particular Anderson heteropolyanions, Keggin heteropolyanions or Strandberg heteropolyanions. Said heteropolyanions preferably have a formula wherein the element X is preferably phosphorus and the element M is preferably one or more elements selected from molybdenum, tungsten, cobalt and nickel. The mesostructured matrix in which said heteropolyanions are trapped is preferably based on aluminium oxide, silicon oxide, a mixture of aluminium and silicon oxide, titanium oxide and zirconium oxide. Preferred heteropolyanions are Anderson heteropolyanions with formula H₆CoMo₆O₂₄³⁻ and H₄Co₂Mo₁₀O₃₈⁶⁻, Keggin heteropolyanions with formula PMo₁₂O₄₀³⁻ and substituted Keggin heteropolyanions with formula PCoMo₁₁O₄₀⁷⁻ or Strandberg heteropolyanions with formula HₕP₂Mo₅O₂₃^{(6-h)-} with h=0, 1 or 2. The Anderson heteropolyanions with formula H₆CoMo₆O₂₄³⁻ and H₄Co₂Mo₁₀O₃₈⁶⁻ may be present alone or as a mixture.

### Feeds (First Particular Implementation of the Transformation Process)

Said gasoline cut treated using said hydrodesulphurization process of the invention is a gasoline cut containing sulphur and olefinic hydrocarbons. It contains hydrocarbons containing at least 2 carbon atoms per molecule, preferably at least 5 carbon atoms per molecule, and has a final boiling point of 250° C. or less. Said gasoline cut is preferably obtained from a coking unit, a visbreaking unit, a steam cracking unit or from a fluid catalytic cracking unit (FCC). Advantageously, said cut may optionally be composed of a significant fraction of a gasoline originating from other production processes such as atmospheric distillation (straight run gasoline) or from conversion processes (coking or steam cracking). Highly preferably, said gasoline cut is a gasoline cut obtained from a catalytic cracking unit with a boiling point range extending from the boiling points of hydrocarbons containing 5 carbon atoms to 250° C.

### Operating Conditions (First Particular Implementation of the Transformation Process)

The process for hydrodesulphurization of a gasoline cut, particularly a catalytically cracked gasoline cut of the invention, is carried out under the following operating conditions: a temperature in the range from approximately 200° C. to 400° C., preferably in the range 250° C. to 350° C., a total pressure in the range 1 MPa to 3 MPa, more preferably in the range 1 MPa to 2.5 MPa, with a ratio of the volume of hydrogen to the volume of gasoline cut in the range 100 to 600 litres per litre, more preferably in the range 200 to 400 litres per litre. Finally, the hourly space velocity (HSV) is the inverse of the contact time expressed in hours. It is defined as the ratio of the volume flow rate of the liquid gasoline cut to the volume of catalyst charged into the reactor. It is generally in the range 1 to 10 h⁻¹, preferably in the range 2 to 8 h⁻¹.

### Implementations (First Particular Implementation of the Transformation Process)

The technical implementation of the hydrodesulphurization process of the invention is, for example, effected by injecting the gasoline cut and hydrogen into at least one fixed bed, moving bed or ebullated bed reactor, preferably into a fixed bed reactor.

In accordance with a particular second implementation of the transformation process of the invention, the process for the transformation of hydrocarbon feeds of the invention is a process for the hydrodesulphurization of a gas oil cut carried out in the presence of a catalyst for which the mesostructured material of the invention is a precursor, said material undergoing said sulphurization step i) in order to carry out its function as a catalyst.

Said hydrodesulphurization (HDS) process of the invention is intended to eliminate the sulphur-containing compounds present in said gas oil cut in order to comply with environmental standards in force, namely a permitted sulphur content of up to 10 ppm from 2009.

The catalyst obtained after sulphurization of the material of the invention is a more active catalyst than the catalysts which are in conventional use in processes for the hydrodesulphurization of gas oil cuts, the improvement in activity being linked to better dispersion of the metal sulphide active phase obtained from the polyoxometallates, preferably the HPAs.

Preferably, the material of the invention used, after sulphurization, as the catalyst for carrying out said process for the hydrodesulphurization of a gas oil cut has a composition such that said metallic particles trapped in each of said mesostructured matrices is in the form of heteropolyanions in which the element X is preferably selected from phosphorus and silicon, the element M is preferably selected from molybdenum, tungsten and a mixture of these two elements, or the element M is preferably selected from a mixture of molybdenum and a metal from group VIII selected from cobalt and nickel, a mixture of tungsten and a metal from group VIII selected from cobalt and nickel. The mesostructured matrix in which said heteropolyanions are trapped is preferably based on an aluminium oxide, a silicon oxide or a mixture of aluminium and silicon oxide (Y=Si, Al or a mixture thereof). Preferred heteropolyanions are the heteropolyanions HPCoMo₁₁O₄₀⁶⁻, PMo₁₂O₄₀³⁻ and PW₁₂O₄₀³⁻ or Strandberg heteropolyanions with formula HₕP₂Mo₅O₂₃^{(6-h)-} in which h=0, 1 or 2.

### Feeds (Second Particular Implementation of the Transformation Process)

The gas oil cut to be hydrodesulphurized using the process of the invention contains 0.04% to 5% by weight of sulphur. It is advantageously obtained from straight run gas oil, from a coking unit, from a visbreaking unit, from a steam cracking unit and/or from a fluid catalytic cracking unit (FCC). Said gas oil cut has a boiling point which is preferably in the range 250° C. to 400° C.

Operating conditions (second particular implementation of the transformation process)

The hydrodesulphurization process of the invention is carried out under the following operating conditions: a temperature in the range from approximately 200° C. to 400° C., preferably in the range 330° C. to 380° C., a total pressure in the range 2 MPa to 10 MPa and more preferably in the range 3 MPa and 7 MPa with a ratio of the volume of hydrogen per volume of hydrocarbon feed in the range 100 to 600 litres per litre and more preferably in the range 200 to 400 litres per litre and an hourly space velocity (HSV) in the range 1 to 10 h⁻¹, preferably in the range 2 to 8 h⁻¹. The HSV is the inverse of the contact time expressed in hours and is defined as the ratio of the volume flow rate of liquid hydrocarbon feed over the volume of catalyst charged into the reaction unit carrying out the process for the hydrotreatment of gas oils of the invention.

### Implementations (Second Particular Implementation of the Transformation Process)

The reaction unit carrying out the process for the hydrodesulphurization of gas oils of the invention is preferably operated in fixed bed, moving bed or ebullated bed mode, preferably in fixed bed mode.

In a third particular implementation of the transformation process of the invention, the process for the transformation of hydrocarbon feeds of the invention is a process for hydrocracking a hydrocarbon feed wherein at least 50% by weight of the compounds has an initial boiling point of more than 340° C. and a final boiling point of less than 540° C., said process being carried out in the presence of a catalyst the mesostructured material of the invention of which is a precursor, said material undergoing said sulphurization step i) in order to fulfil its role as a catalyst.

Said hydrocracking process essentially consists of producing lighter, very high quality fractions such as gasolines or middle distillates, in particular jet fuels and light gas oils, from low quality heavy feeds. It can also be used to obtain a highly purified residue which can be used as an excellent oil base. In general, the hydrocracking catalysts used in the hydrocracking processes are all bifunctional in nature, associating an acid function with a hydrodehydrogenating function. In the hydrocracking process of the invention, the acid function is provided either by using an acidic aluminosilicate type matrix as the mesostructured matrix in the material of the invention, or by introducing/trapping nanocrystals of zeolite in the mesostructured oxide matrix, preferably based on an aluminium oxide or a silicon oxide, or by using, as the mesostructured matrix in the material of the invention, an acid matrix of the aluminosilicate type in which zeolitic nanocrystals are trapped. The balance between the two acid functions, acid and hydrodehydrogenating, is one of the key parameters which governs the activity and selectivity of the catalyst. In accordance with said hydrocracking process of the invention, the hydrodehydrogenating function is provided by the element or elements M present in the metallic particles in the form of polyoxometallates, preferably in the form of heteropolyanions, said element(s) M being as hereinbefore defined.

The catalyst obtained after sulphurization of the material of the invention results in optimal catalytic performances when it is used in a hydrocracking process compared with catalysts which are conventionally used in such a process. In particular, it can be used to obtain catalytic performances which are at least equivalent to those obtained with existing catalysts while necessitating a substantially reduced quantity of active phase, in particular of metal(s) providing the hydrodehydrogenating function such as molybdenum and/or tungsten.

The catalyst obtained after sulphurization of the material of the invention is advantageous in improving the dispersion of the hydrodehydrogenating phase and the control of the size of the sulphide particles.

Preferably, the material of the invention used, after sulphurizing, as a catalyst for carrying out said process for hydrocracking of a hydrocarbon feed, has a composition such that said metallic particles trapped in each of said mesostructured matrices is in the form of heteropolyanions in which the element X is preferably selected from phosphorus and silicon, the element M is preferably selected from molybdenum, tungsten and a mixture of these two elements, or the element M is preferably selected from a mixture of molybdenum and a metal from group VIII selected from cobalt and nickel, and a mixture of tungsten and a metal from group VIII selected from cobalt and nickel. The mesostructured matrix in which said heteropolyanions are trapped is preferably based on aluminium oxide, silicon oxide or a mixture of aluminium oxide and silicon oxide (Y=Si, Al or a mixture thereof). Preferred heteropolyanions are Keggin heteropolyanions, in particular the heteropolyanion with formula PW₁₂O₄₀³⁻.

### Feeds (Third Particular Implementation of the Transformation Process)

Said hydrocarbon feed employed in the hydrocracking process of the invention is a hydrocarbon feed for which at least 50% by weight of the compounds have an initial boiling point of more than 340° C. and a final boiling point of less than 540° C., preferably for which at least 60% by weight, preferably for which at least 75% by weight and more preferably for which at least 80% by weight of the compounds have an initial boiling point of more than 340° C. and a final boiling point of less than 540° C.

Said hydrocarbon feed is advantageously selected from vacuum distillate (VD), effluents obtained from FCC (fluid catalytic cracking), light gas oils obtained from a catalytic cracking unit (LCO, light cycle oil), heavy oils (HCO, heavy cycle oil), paraffin effluents obtained from Fischer-Tropsch synthesis, effluents obtained from vacuum distillation such as gas oil fractions of the VGO (vacuum gas oil) type, effluents obtained from the coal liquefaction process, feeds obtained from biomass or effluents originating from the conversion of feeds obtained from biomass, and aromatic extracts and feeds deriving from aromatic extraction units, alone or as a mixture.

Preferably, said hydrocarbon feed is a vacuum distillate cut. The vacuum distillate is generally obtained from vacuum distillation of crude oil. Said vacuum distillate cut comprises aromatic compounds, olefinic compounds, naphthenic compounds and/or paraffinic compounds.

Said vacuum distillate cut advantageously comprises heteroatoms selected from nitrogen, sulphur and a mixture of these two elements. When nitrogen is present in said feed to be treated, the nitrogen content is 500 ppm or more; preferably, said content is in the range 500 to 10000 ppm by weight, more preferably in the range 700 to 4000 ppm by weight and still more preferably in the range 1000 to 4000 ppm. When sulphur is present in said feed to be treated, the sulphur content is in the range 0.01% to 5% by weight, preferably in the range 0.2% to 4% by weight and still more preferably in the range 0.5% to 3% by weight. Said vacuum distillate may optionally and advantageously contain metals, in particular nickel and vanadium. The cumulative content of nickel and vanadium in said vacuum distillate cut is preferably less than 1 ppm by weight. The asphaltenes content of said hydrocarbon feed is generally less than 3000 ppm, more preferably less than 1000 ppm, and still more preferably less than 200 ppm.

In a preferred implementation, said vacuum distillate (VD) type hydrocarbon feed may be used as it is, i.e. alone, or as a mixture with other hydrocarbon cuts, preferably selected from effluents obtained from the FCC unit (fluid catalytic cracking), light gas oils obtained from a catalytic cracking unit (LCO, light cycle oil), heavy oil cuts (HCO, heavy cycle oil), atmospheric residues and vacuum residues obtained from the atmospheric and vacuum distillation of crude oil, paraffinic effluents obtained from Fischer-Tropsch synthesis, effluents obtained from vacuum distillation such as, for example, VGO (vacuum gas oil) type gas oil fractions, deasphalted oils, DAO, effluents obtained from the coal liquefaction process, feeds obtained from biomass or effluents derived from the conversion of feeds obtained from biomass, and aromatic extracts and feeds deriving from aromatic extraction units, alone or as a mixture. In the preferred case in which said vacuum distillate (VD) type hydrocarbon feed is used as a mixture with other hydrocarbon cuts, said hydrocarbon cuts added alone or as a mixture are present in an amount of at most 50% by weight of said mixture, preferably at most 40% by weight, more preferably at most 30% by weight and still more preferably at most 20% by weight of said mixture.

### Operating Conditions (Third Particular Implementation of the Transformation Process)

The hydrocracking process in accordance with the invention is carried out under operating conditions (temperature, pressure, hydrogen recycle ratio, hourly space velocity) which may vary widely as a function of the nature of the feed, the quality of the desired products and the units available to the refiner. In accordance with the hydrocracking process of the invention, said hydrocracking catalyst is advantageously brought into contact, in the presence of hydrogen, with said hydrocarbon feed at a temperature of more than 200° C., usually in the range 250° C. to 480° C., advantageously in the range 320° C. to 450° C., preferably in the range 330° C. to 435° C., at a total pressure of more than 1 MPa, usually in the range 2 to 25 MPa, preferably in the range 3 to 20 MPa, the hourly space velocity (volume flow rate of feed divided by the volume of catalyst) being in the range 0.1 to 20 h⁻¹, preferably in the range 0.1 to 6 h⁻¹, preferably in the range 0.2 to 3 h⁻¹, and the quantity of hydrogen introduced being such that the volume ratio of the litres of hydrogen/litre of hydrocarbon is in the range 80 to 5000 L/L and usually in the range 100 to 2000 L/L.

These operating conditions used in the hydrocracking process of the invention can generally be used to obtain conversions per pass into products with boiling points of at most 370° C., advantageously at most 340° C., of more than 15%, more preferably in the range 20% to 95%.

### Implementations (Third Particular Implementation of the Transformation Process)

The hydrocracking process covers pressure and conversion ranges from mild hydrocracking to high pressure hydrocracking. The term “mild hydrocracking” means hydrocracking resulting in moderate conversions, generally less than 40%, and operating at low pressures, generally in the range 2 MPa to 10 MPa. The catalyst used in said hydrocracking process of the invention may be used alone, in one or more catalytic beds, in fixed bed or ebullated bed mode, in one or more reactors, in a hydrocracking setup known as a once-through step or a two-step process which are known to the skilled person, with or without liquid recycling of the unconverted fraction, optionally in association with a hydrorefining catalyst located upstream of the catalyst used in the hydrocracking process of the invention.

In a fourth particular implementation of the transformation process of the invention, the process for the transformation of hydrocarbon feeds of the invention is a process for hydroconversion of a heavy hydrocarbon feed for which at least 55% by weight of the compounds have a boiling point of 540° C. or more, said process being carried out in the presence of a catalyst the mesostructured material of the invention of which is a precursor, said material undergoing said sulphurization step i) in order to fulfil its role as a catalyst.

Said hydroconversion process of the invention consists of hydrotreating and transforming oil fractions termed “heavy” fractions containing metallic impurities into lighter fractions with the aim of producing feeds which can be used in conversion processes such as fluid catalytic cracking (FCC) or hydrocracking, or of producing fuels, including fuel oils, which comply with specifications in force. Thus, said hydroconversion process can be used to reduce the sulphur content: when present in a content in the range 3% to 6% by weight in the feeds to be treated, the sulphur content is generally less than 1% by weight in the effluent obtained from the hydroconversion process of the invention. Similarly, the nitrogen content is advantageously reduced by at least 70% by weight and the elimination of metals, in particular nickel and vanadium, initially present in the feeds to be treated in an amount of a few tens to a few hundred ppm is advantageously intense in order to obtain conversions of the order of 80% to 90% (i.e. usually, the quantity of metals, in particular nickel and vanadium, is less than 100 ppm by weight, preferably less than 50 ppm by weight in the effluent).

The catalyst obtained after sulphurization of the material of the invention can be used to limit the phenomenon of sintering the active phase while ensuring the reagents and the reaction products good access to the active surface of the catalyst. In particular, the stability to sintering when operating at high temperatures or during regeneration treatments is better than that of known catalysts the active phase of which is not obtained from polyoxometallate species, in particular from heteropolyanions.

Preferably, the material of the invention used, after sulphurization, as a catalyst for carrying out said process for hydroconversion of a heavy hydrocarbon feed, has a composition such that said metallic particles trapped in each of said mesostructured matrices is in the form of heteropolyanions in which the element X is preferably selected from phosphorus, silicon and boron, the element M is preferably selected from molybdenum, tungsten and the mixture of these two elements or the element M is preferably selected from a mixture of molybdenum and a metal from group VIII selected from cobalt and nickel, a mixture of tungsten and a metal from group VIII selected from cobalt and nickel. The mesostructured matrix in which said heteropolyanions are trapped is preferably based on an aluminium oxide, a silicon oxide or a mixture of aluminium oxide and silicon oxide (Y=Si, Al or a mixture thereof). Preferred heteropolyanions are Strandberg heteropolyanions, for example the heteropolyanion with formula H₂P₂Mo₅O₂₃⁴⁻.

These steps are generally carried out at a high hydrogen pressure and at high temperature in fixed bed or ebullated bed type reactors as a function of the quantity of metallic contaminants in the feeds.

### Feeds (Fourth Particular Implementation of the Transformation Process)

The hydrocarbon feed employed in the hydroconversion process in accordance with the invention is a hydrocarbon feed for which at least 55% by weight of the compounds have an initial boiling point of more than 540° C., preferably at least 65% by weight, preferably at least 75% by weight and more preferably for which at least 85% by weight of the compounds have an initial boiling point of more than 540° C.

Said hydrocarbon feed for which at least 55% by weight of the compounds have an initial boiling point of more than 540° C. is advantageously selected from deasphalted oils, atmospheric residues and vacuum residues, taken alone or as a mixture; preferably, said feed is a deasphalted oil or DAO. Said deasphalted oil is also termed a deasphalted residue in the remainder of the text.

Said deasphalted residue or DAO type feed has the advantage of not containing an asphaltene fraction containing a large quantity of coke and metals. Said deasphalted residue or DAO type feed is obtained from vacuum distillation residues (VDR) cuts obtained from vacuum distillation of crude oil, or from residues from conversion processes such as coking, after a deasphalting treatment that can be used to eliminate the asphaltenes by an extraction operation using a paraffinic solvent, preferably selected from propane, pentane and heptane. The residual content of asphaltenes in said deasphalted residue type feed obtained from this deasphalting step is preferably less than 1% by weight, and can be used to obtain significantly longer cycle times for the subsequent conversion processes carried out on said deasphalted residue type feed.

In a preferred implementation, said deasphalted residue or DAO type feed may be used as it is, i.e. alone, or as a mixture with other hydrocarbon feeds preferably selected from vacuum distillates with a boiling point in the range 340° C. to 540° C., effluents from a FCC catalytic cracking unit, light gas oils obtained from a catalytic cracking unit (or LCO), heavy oil cuts (HCO), distillates deriving from processes for the desulphurization or hydroconversion of atmospheric residues and/or vacuum residues carried out in a fixed bed or ebullated bed, paraffinic effluents obtained from Fischer-Tropsch synthesis, effluents obtained from vacuum distillation such as, for example, VGO (vacuum gas oil) type gas oil fractions, effluents obtained from the coal liquefaction process, feeds obtained from biomass or effluents deriving from the conversion of feeds obtained from biomass, and aromatic extracts and feeds deriving from aromatic extraction units, used alone or as a mixture. In the preferred case in which said feed of the deasphalted residue or DAO type is used as a mixture with other hydrocarbon cuts, said hydrocarbons cuts added alone or as a mixture are present in an amount of at most 45% by weight of said mixture, preferably at most 35% by weight, more preferably at most 25% by weight and still more preferably at most 15% by weight of said mixture.

### Operating Conditions and Implementation (Fourth Particular Implementation of the Transformation Process)

The hydroconversion catalyst wherein the mesostructured material of the invention is a precursor may be used in a fixed bed reactor at a temperature which is generally in the range 320° C. to 450° C., preferably in the range 350° C. to 410° C., at a partial pressure of hydrogen in the range from approximately 3 to 30 MPa, preferably in the range 10 to 20 MPa, and at an hourly space velocity in the range 0.05 to 5 volumes of feed per volume of catalyst per hour, preferably in the range 0.2 to 0.5. The ratio of gaseous hydrogen to liquid feed, expressed in normal cubic metres, is in the range 200 to 5000 Nm³, preferably in the range 500 to 1500 Nm³.

The hydroconversion catalyst wherein the mesostructured material of the invention is a precursor may also be used in an ebullated bed reactor at a temperature in the range 320° C. to 470° C., preferably in the range 400° C. to 450° C., at a partial pressure of hydrogen in the range from approximately 3 to 30 MPa, preferably in the range 10 to 20 MPa, and at an hourly space velocity in the range 0.1 to 10 volumes of feed per volume of catalyst per hour, preferably in the range 0.2 to 2, and with a ratio of gaseous hydrogen at the inlet to the volume of liquid feed in the range 100 to 3000 Nm³, preferably in the range 200 to 1200 Nm³.

Preferably, said hydroconversion catalyst is used in an ebullated bed reactor.

In accordance with a fifth particular implementation of the transformation process in accordance with the invention, the process for the transformation of hydrocarbon feeds in accordance with the invention is a process for the hydrotreatment of a heavy hydrocarbon feed in which at least 50% by weight, preferably at least 70% by weight, of the hydrocarbon compounds present in said charge have a boiling point greater than or equal to 370° C., said process comprising at least one first step for hydrodemetallization of said charge followed by a second step for hydrotreatment carried out in the presence of a catalyst wherein the mesostructured material in accordance with the invention is a precursor, said material undergoing said sulphurization step i) in order to fulfil its role as a catalyst.

Said two-step hydrotreatment process in accordance with said fifth particular mode can, for example, be used to produce a heavy fuel oil with an improved purity which satisfies specifications in force, or a feed which can be upgraded in conversion processes such as catalytic cracking or hydrocracking, which can then be used as a base for the production of fuels.

Said two-step hydrotreatment process is aimed at treating a heavy hydrocarbon feed wherein at least 50% by weight, preferably at least 70% by weight, of the hydrocarbon compounds present in said charge have a boiling point greater than or equal to 370° C., in order to obtain a hydrocarbon fraction with an improved, i.e. higher, hydrogen to carbon (H/C) ratio, and wherein the quantity of impurities is substantially reduced. The impurities present in said feed are in particular sulphur, nitrogen, Conradson carbon, asphaltenes and metals, in particular vanadium and nickel. Said hydrotreatment process comprises a first step consisting of pre-treating said hydrocarbon feed in order to reduce the quantity of metals (hydrodemetallization), asphaltenes, nitrogen and Conradson carbon. The second step, carried out after the first step, consists of reducing the sulphur content (hydrodesulphurization), nitrogen content (hydrodenitrogenation) and aromatic compounds content. More particularly, said second step is essentially aimed at reducing the quantity of sulphur in the pre-treated feed in said first step and is advantageously assimilated into a hydrodesulphurization step. The feed treated by the catalyst employed in said second step, said catalyst having been obtained after sulphurization of the material of the invention, is notably depleted in metals and in asphaltenes. The material of the invention used, after sulphurization, as a catalyst in order to carry out said second step can be used to optimize the transfer of material into said catalyst and to develop an active phase in said catalyst which is better dispersed and thus more active than the active phases conventionally used in heavy feed hydrotreatment. The material of the invention used, after sulphurization, as a catalyst can also be used to limit the risks of sintering of the active phase which are well known to the skilled person.

### Feeds (Fifth Particular Implementation of Said Transformation Process)

The heavy hydrocarbon feeds, for which at least 50% by weight, preferably at least 70% by weight, of the hydrocarbon compounds have a boiling point greater than or equal to 370° C., which are to be hydrotreated in accordance with the process which forms the subject matter of the fifth implementation are, for example, vacuum distillates, atmospheric residues, straight run vacuum residues, deasphalted oils, residues obtained from conversion processes such as those deriving from a coking unit or from a fixed bed, ebullated bed or moving bed hydroconversion unit and mixtures of each of these cuts. Said hydrocarbon feeds to be hydrotreated are advantageously constituted either by one or more cuts or by one or more of said cut(s) diluted with a hydrocarbon fraction or a mixture of hydrocarbon fractions may be selected from a light cycle oil (LCO), a heavy oil cut (HCO), a decanted oil (DO), a slurry, products obtained from the FCC process or directly from distillation, gas oil fractions, in particular those obtained by vacuum distillation known as VGO (vacuum gas oil). Said heavy hydrocarbon feeds to be hydrotreated may advantageously in some cases comprise one or more cuts obtained from the coal liquefaction process as well as aromatic extracts.

Said heavy feeds to be hydrotreated in accordance with the process which form the subject matter of said fifth implementation may advantageously be mixed with coal in the form of a powder; this mixture is generally termed a slurry. Said feeds then advantageously include by-products obtained from the conversion of coal and re-mixed with fresh coal. The quantity of coal in said heavy feeds to be hydrotreated is such that the feed/coal volume ratio is in the range 0.1 to 1, preferably in the range 0.15 to 0.3. The coal may contain lignite, and may be a sub-bituminous coal or it may be bituminous. Any type of coal is suitable for carrying out said hydrotreatment process.

Said heavy hydrocarbon feeds to be hydrotreated in accordance with said two step hydrotreatment process advantageously contains 0.5% to 6% by weight of sulphur. They generally contain more than 1% by weight of molecules with a boiling point of more than 500° C. They have a metals content, in particular nickel and vanadium, of more than 1 ppm by weight, preferably more than 20 ppm by weight, and an asphaltenes content, defined as the fraction of the feed precipitating in heptane, of more than 0.05% by weight, which is preferably more than 1% by weight.

### Operating Conditions (Fifth Particular Implementation of Said Transformation Process)

Said hydrodemetallization step (first step) and said hydrotreatment step, more preferably said hydrodesulphurization step (second step) carried out in the hydrotreatment process of the invention may be carried out in fixed bed or ebullated bed reactors. Advantageously, said hydrodemetallization step is carried out in a reactor operating in ebullated bed mode and said hydrotreatment step, more preferably said hydrodesulphurization step, is carried out in a reactor operating in fixed bed mode.

When one and/or the other of said first and second steps is (are) carried out in a reactor operating in fixed bed mode, the operating conditions are as follows: a temperature in the range 320° C. to 450° C., preferably in the range 350° C. to 410° C., at a partial pressure of hydrogen in the range from approximately 3 to 30 MPa, preferably in the range 10 to 20 MPa, ant at an hourly space velocity in the range 0.05 to 5 volumes of feed per volume of catalyst per hour, preferably in the range 0.2 to 0.5. The ratio of gaseous hydrogen at the inlet to the liquid feed, expressed in normal cubic metres, is in the range 200 to 5000 Nm³, preferably in the range 500 to 1500 Nm³.

When one and/or the other of said first and second steps is (are) carried out in a reactor operating in ebullated bed mode, the operating conditions are as follows: a temperature in the range 320° C. to 470° C., preferably in the range 400° C. to 450° C., at a partial pressure of hydrogen in the range 3 to 30 MPa, preferably in the range 10 to 20 MPa, at an hourly space velocity of approximately 0.1 to 10 volumes of feed per volume of catalyst per hour, preferably in the range 0.2 to 2, and with a ratio of gaseous hydrogen at the inlet to the volume of liquid feed in the range 100 to 3000 Nm³, preferably in the range 200 to 1200 Nm³.

### Implementation (Fifth Particular Implementation of Said Transformation Process)

The hydrotreatment catalyst, wherein the mesostructured material in accordance with the invention is a precursor, may be used in any process, known to the skilled person, for the hydrotreatment of heavy hydrocarbon feeds, for example atmospheric residues or vacuum residues. It may be carried out in any type of reactor operated in fixed bed or in moving bed or in ebullated bed mode.

The catalyst used to carry out said first step, termed the hydrodemetallization or pre-treatment step, of said two step hydrotreatment process, advantageously has a bimodal porosity (U.S. Pat. No. 7,119,045) or a multimodal porosity (EP 0.098.764 and EP 1.579.909) on which metals from group VIB (molybdenum or tungsten) and group VIII (nickel, cobalt or iron) or group VB (vanadium) are deposited. The hydrodemetallization catalyst comprises 1% to 30% by weight with respect to the total mass of trioxide of at least one element from group VIB, preferably 2% to 20% by weight and more preferably 2% to 10% by weight. The hydrodemetallization catalyst also comprises 0 to 2.2% by weight with respect to the total mass of oxide of at least one element from group VIII, preferably 0.5% to 2% by weight, and more preferably 0.5% to 1.5% by weight. Furthermore, the hydrodemetallization catalyst contains between 0 and 15% by weight with respect to the total mass of at least one element from group VB, preferably in the range 0 to 10% by weight and more preferably in the range 0.2% to 5% by weight. It may contain doping elements selected from phosphorus, boron, titanium, silicon and fluorine. The quantity of boron or phosphorus pentoxide is advantageously in the range 0 to 10% by weight, preferably in the range 0.2% to 7%, and still more preferably in the range 0.5% to 5%. The catalyst used in the first step of the hydrotreatment process has a BET surface area of more than 50 m²/g, preferably more than 80 m²/g. The pore volume occupied by pores with a diameter of more than 50 nm is greater than or equal to 0.1 mL/g, preferably greater than or equal to 0.15 mL/g. The total pore volume, measured by mercury porosimetry, is advantageously in the range 0.5 and 1.5 mL/g, preferably in the range 0.7 to 1.2 mL/g and still more preferably in the range 0.8 mL/g to 1.2 mL/g, with a mesopore pore distribution (diameter less than 50 nm) centred on a mean diameter in the range 4 to 17 nm, preferably in the range 7 to 16 nm and still more preferably in the range 10 to 15 nm.

The material in accordance with the invention used, following sulphurization, as the catalyst for carrying out said second step of the hydrotreatment process has an advantageous composition and structure for reducing the sulphur content (hydrodesulphurization), nitrogen content (hydrodenitrogenation) and aromatic compounds content and for continuing the reduction of the quantity of metals started in said first step. Preferably, the material of the invention used after sulphurization as a catalyst for carrying out said second step has a composition such that said metallic particles trapped in each of said mesostructured matrices are in the form of heteropolyanions in which the element X is preferably selected from phosphorus and silicon, the element M is preferably selected from molybdenum, tungsten and a mixture of these two elements, or the element M is preferably selected from a mixture of molybdenum and a metal from group VIII selected from cobalt and nickel, a mixture of molybdenum and a metal from group VB selected from vanadium, niobium and tantalum. The mesostructured matrix in which said heteropolyanions are trapped is preferably based on an aluminium oxide, a silicon oxide or a mixture of aluminium and silicon oxide (Y=Si, Al or a mixture thereof). Preferred heteropolyanions are the heteropolyanions PMo₁₂O₄₀³⁻, HPNiMo₁₁O₄₀⁶⁻, and PVMo₁₁O₄₀⁴⁻.

The total quantity of molybdenum and/or tungsten by weight is advantageously in the range 1% to 30%, expressed as the % by weight of oxide with respect to the final mass of material, preferably in the range 2% to 20% and more preferably in the range 4% to 15%. The total quantity by weight of metal from group VIII selected from cobalt and nickel and of metal from group VB selected from vanadium, niobium and tantalum is advantageously in the range 0 to 15% expressed as the % by weight of oxide with respect to the final material mass, preferably in the range 0.5% to 10% and more preferably in the range 1% to 8%. A doping element selected from phosphorus, silicon, boron and fluorine is advantageously added. The preferred doping element is phosphorus. The quantities of doping elements are in the range 0.5% to 10% by weight, preferably in the range 1% to 8% by weight and more preferably in the range 2% to 6% by weight. The atomic ratio between the doping element and the element from group VIII selected from cobalt and nickel is preferably selected to be between 0 and 0.9, more preferably between 0.2 and 0.8.

In accordance with a sixth particular implementation of the transformation process of the invention, the process for the transformation of hydrocarbon feeds in accordance with the invention is a process for the hydrotreatment of a hydrocarbon feed comprising triglycerides, said process being carried out in the presence of a catalyst the mesostructured material of the invention of which is a precursor, said material undergoing step 1) for sulphurization in order to fulfil its role as a catalyst.

More particularly, said hydrotreatment process consist of producing hydrocarbon bases of the middle distillate type (gas oil, kerosene) from hydrocarbon feeds obtained from renewable sources.

### Aim of the Process

The international context of the years 2005-2010 is firstly marked by the rapid growth of the need for fuels, in particular gas oil bases, in the European community and then by the major problems linked to global warming and to the emission of greenhouse gases. This gave rise to a desire to reduce the dependence on fossil starting materials for energy and to reduce CO₂ emissions. In this context, the search for novel hydrocarbon feeds obtained from renewable sources which can easily be integrated into the traditional refining and fuel production set-up constitutes a challenge of growing importance. In this context, the integration of novel products of vegetable origin into the refining process obtained from the conversion of lignocellulose biomass or obtained from the production of vegetable oils or animal fats has in the last few years surged in interest due to the increasing cost of fossil materials. Similarly, traditional biofuels (principally ethanol or methyl esters of vegetable oils) have acquired a genuine status as a complement to oil bases in fuel pools.

The very high molecular mass (more than 600 g/mole) of triglycerides, which are essential compounds of renewable sources, and the high viscosity of the feeds under consideration mean that using them directly or mixed in gas oils poses problems for modern HDI type engines which are turbocharged direct injection diesel engines (incompatible with the very high pressure injection pumps, injector fouling problems, uncontrolled combustion, low yields, toxic emissions of unburned substances). However, the hydrocarbon chains which are present in the triglycerides are essentially linear and their length (number of carbon atoms) is compatible with the hydrocarbons present in the gas oils. Thus, it is necessary to transform these feeds in order to obtain a good quality gas oil base and/or a kerosene cut that satisfies existing specifications, after mixing or adding an additive as is known by the skilled person. For diesel, the final fuel has to comply with standard EN590 and for kerosene, it has to comply with the specifications described in the IATA (International Air Transport Association) Guidance Material for Aviation Turbine Fuel Specifications, 6^{th} edition, May 2008, such as ASTM standard D1655.

The hydrotreatment of hydrocarbon feeds comprising triglycerides, in particular vegetable oils, employs complex reactions which are favoured by a hydrogenating catalytic system. These reactions in particular comprise:

the hydrogenation of unsaturated bonds, i.e. carbon-carbon double bonds present on the hydrocarbon chains of the triglycerides and all of the fats present in the feed to be hydrotreated;

deoxygenation using three reaction pathways:
hydrodeoxygenation: elimination of the oxygen by consumption of hydrogen and resulting in the formation of water;
decarboxylation/decarbonylation: the elimination of oxygen with the formation of carbon monoxide and dioxide: CO and CO₂;

hydrodenitrogenation: the elimination of nitrogen by the formation of NH₃.

The presence of unsaturated bonds renders said feed thermally unstable. Further, the hydrogenation of these unsaturated bonds is highly exothermic. The process for the hydrotreatment of hydrocarbon feeds comprising triglycerides is particularly flexible and can be used to treat feeds which are very different in terms of unsaturated bonds, such as soya oils or palm oils, for example, or oils of animal origin or obtained from algae, and can be used to trigger the hydrogenation of unsaturated bonds at a temperature which is as low as possible, avoiding any heating up in contact with a wall which could cause hot spots in said feed, inducing the formation of gums and causing fouling and an increase in the pressure drop over the catalyst bed or beds.

The catalyst obtained after sulphurizing the material of the invention leads to optimized catalytic performances when it is used in the process for the hydrotreatment of a hydrocarbon feed comprising triglycerides. In particular, it can be used for the production of paraffins from feeds obtained from renewable hydrocarbon sources, complying with fuel specifications and in particular complying with standards in force for diesel and kerosene fuels. It can be used to limit the formation of a phase which is refractory to sulphurization and to operate the hydrotreatment process at a more moderate temperature.

Preferably, the material of the invention used after sulphurization as a catalyst for carrying out said process for the hydrotreatment of a hydrocarbon feed has a composition such that said metallic particles trapped in each of said mesostructured matrices is in the form of heteropolyanions in which the element X is preferably selected from phosphorus, boron and silicon, the element M is preferably selected from molybdenum, tungsten and a mixture of these two elements, or the element M is preferably selected from a mixture of molybdenum and a metal from group VIII selected from cobalt and nickel, and a mixture of tungsten and a metal from group VIII selected from cobalt and nickel. The mesostructured matrix in which said heteropolyanions are trapped is preferably based on an aluminium oxide, a silicon oxide or a mixture of aluminium oxide and silicon oxide (Y=Si, Al or a mixture thereof). Preferred heteropolyanions are Strandberg heteropolyanions, in particular the heteropolyanion with formula H₂P₂Mo₅O₂₃⁴⁻.

### Feeds (Sixth Particular Implementation of the Transformation Process)

Examples of feeds obtained from renewable sources which may be used in the hydrotreatment process of the invention which may be cited are vegetable oils (food quality or otherwise) or oils obtained from algae, animal fats or spent frying oil, or unrefined frying oil or oil which has undergone a treatment, as well as mixtures of such feeds. These feeds essentially contain the chemical structures of the triglyceride type, which the skilled person also terms fatty acid triesters. A fatty acid triester or triglyceride is composed of three fatty acid hydrocarbon chains. The hydrocarbon chains which constitute these triglyceride type molecules are essentially linear and generally have between 0 and 3 unsaturated bonds per chain, but this may be higher for oils obtained from algae.

The vegetable oils and other feeds of renewable origin also include various impurities, in particular compounds containing heteroatoms such as nitrogen and elements such as Na, Ca, P, Mg. The feeds obtained from renewable sources used in the hydrotreatment process of the present invention are advantageously selected from oils and fats of vegetable or animal origin, and mixtures of said feeds, containing triglycerides. They also advantageously contain free fatty acids and/or free fatty acid esters. The vegetable oils may advantageously be unrefined or refined, completely or partially, and obtained from the following vegetables: rape, sunflower, soya, palm, palm kernel, olive, coconut, jatropha; this list is not limiting. Oils from algae or from fish are also pertinent. The animal fats are advantageously selected from lard or fats composed of residues from the food industry or obtained from the catering industry. These feeds essentially contain chemical structures of the triglyceride type composed of three fatty acid chains. They may also contain fatty acid chains in the form of free fatty acids. All fatty acid chains present in the feed each have a number of unsaturated bonds per chain, also known as the number of carbon-carbon double bonds per chain, which is generally in the range 0 to 3, but which may be higher, in particular for oils obtained from algae which may have a number of unsaturated bonds per chain of 5 or 6. The molecules present in the feeds obtained from the renewable sources used in the present invention thus has a number of unsaturated bonds, expressed per molecule of triglyceride, which is advantageously in the range 0 to 18. In these feeds, the degree of unsaturation, expressed as the number of unsaturated bonds per fatty hydrocarbon chain, is advantageously in the range 0 to 6. The feeds obtained from renewable sources generally also comprise various impurities, in particular heteroatoms such as nitrogen. The quantities of nitrogen in the vegetable oils are generally in the range approximately 1 ppm to 100 ppm by weight, depending on their nature. They may be up to 1% by weight for particular feeds. These feeds may be used pure or as a mixture with oil effluents such as straight run gas oils or vacuum distillates.

### Operating Conditions (Sixth Particular Implementation of the Transformation Process)

The hydrotreatment process in accordance with the invention is carried out under the following operating conditions: a temperature in the range 250° C. to 400° C., a pressure in the range 1 MPa to 10 MPa, and preferably in the range 3 MPa to 10 MPa and still more preferably in the range 3 MPa to 6 MPa, an hourly space velocity in the range 0.1 h⁻¹ to 10 h⁻¹ and preferably in the range 0.2 to 5 h⁻¹. The total quantity of hydrogen mixed with the liquid feed to be hydrotreated is such that the hydrogen/hydrocarbons ratio in the catalytic zone or zones is in the range 200 to 2000 Nm³ of hydrogen/m³ of feed, preferably in the range 200 to 1800 and highly preferably in the range 500 to 1600 Nm³ of hydrogen/m³ of feed. The stream of hydrogen-rich gas may advantageously come from a makeup of hydrogen and/or a recycle of gaseous effluent obtained from the separation step described below, the gaseous effluent containing a hydrogen-rich gas which has undergone one or more intermediate purification treatments before being recycled and mixed.

### Implementations (Sixth Particular Implementation of the Transformation Process)

The hydrotreatment catalyst, the mesostructured material in accordance with the invention of which is a precursor, may be used in any process which is known to the skilled person which can be used to produce gas oils and/or kerosene. It may be carried out in any type of reactor operated in fixed bed mode, alone or in combination with another catalyst. Following the hydrotreatment step, the effluent produced undergoes a separation step in order to obtain a gaseous effluent and a hydrotreated liquid effluent at least a portion of which is recycled upstream of the hydrotreatment reaction zone. The gaseous effluent contains mainly hydrogen, carbon monoxide and carbon dioxide, light hydrocarbons containing 1 to 5 carbon atoms and steam. The aim of this separation step is thus to separate the gases from the liquid, and in particular to recover the hydrogen-rich gases as well as at least one hydrotreated liquid effluent preferably having a nitrogen content of less than 1 ppm by weight.

The hydrotreated liquid effluent is essentially constituted by n-paraffins which are advantageously incorporated into the gas oil pool and/or into the kerosene pool. In order to improve the cold properties of this hydrotreated liquid effluent, an optional hydroisomerization step is preferably carried out in order to transform the n-paraffins into branched paraffins with better cold properties. The hydroisomerization step is advantageously carried out in a separate reactor, but in the case in which the hydroisomerization catalyst is identical to that of the hydrotreatment step and thus to the catalyst of the invention, the whole process can be carried out in a single step in the same reactor containing one or more catalytic zones. The optional hydroisomerization step operates at a temperature in the range 150° C. to 500° C., preferably in the range 150° C. to 450° C., and highly preferably in the range 200° C. to 450° C., at a pressure in the range 1 MPa to 10 MPa, preferably in the range 2 MPa to 10 MPa and highly preferably in the range 1 MPa to 9 MPa, at an hourly space velocity which is advantageously in the range 0.1 h⁻¹ to 10 h⁻¹, preferably in the range 0.2 to 7 h⁻¹ and highly preferably in the range 0.5 to 5 h⁻¹, at a hydrogen flow rate such that the volume ratio of hydrogen/hydrocarbons is advantageously in the range 70 to 1000 Nm³/m³ of feed, in the range 100 to 1000 normal m³ of hydrogen per m³ of feed and preferably in the range 150 to 1000 normal m³ of hydrogen per m³ of feed. Preferably, the optional hydroisomerization step is carried out in co-current mode.

At least a portion, preferably all of the hydrotreated effluent or the hydrotreated and hydroisomerized effluent then advantageously undergoes one or more separation steps. The aim of this step is to separate the gases from the liquid, and in particular to recover the hydrogen-rich gases which may also contain light compounds such as the C₁-C₄ cut and various liquid effluents, in particular at least one gas oil cut (250° C.+ cut), at least one kerosene cut (150-250° C. cut) of good quality and at least one naphtha cut which may advantageously be sent to a steam cracking or catalytic reforming unit.

The products, gas oil and kerosene, obtained using the hydrotreatment process of the invention and in particular after hydroisomerization, are endowed with excellent characteristics. After mixing with a crude oil-based gas oil obtained from a renewable feed such as coke or lignocellulose biomass and/or with an additive, the gas oil base obtained is of excellent quality: its sulphur content is less than 10 ppm by weight, its total aromatics content is less than 5% by weight and the polyaromatics content is less than 2% by weight, its cetane index is excellent, namely more than 55, its density is less than 840 kg/m³ and usually more than 820 kg/m³, its kinematic viscosity at 40° C. is 2 to 8 mm²/s, and its cold properties are compatible with existing standards, with a limiting filterability temperature at −15° C. and a cloud point of less than −5° C.

The kerosene cut obtained after mixing with an oil-based kerosene obtained from a renewable feed such as coke or lignocellulose biomass and/or with an additive has the following characteristics: a density in the range 775 to 840 kg/m³, a viscosity at −20° C. of less than 8 mm²/s, a crystal disappearance point of less than −47° C., a flash point of more than 38° C., and a smoke point of more than 25 mm.

The invention will now be illustrated by means of the following examples.

### EXAMPLES

In the examples below, the aerosol technique used was that described above in the disclosure of the invention. Based on the synthesis protocols described, the quantities of material in the catalysts were adapted as a function of the envisaged applications. The dispersive Raman spectrometer used was a commercial LabRAM Aramis apparatus supplied by Horiba Jobin-Yvon. The laser used had an excitation wavelength of 532 nm. The operation of this spectrograph in the execution of the examples below was described above.

### Example 1

### Preparation of a Material a in Accordance with the Invention Having HPAs of the Anderson Type with Formula H₆CoMo₆O₂₄³⁻, 3/2Co²⁺ (Denoted CoMo₆(Co)) and H₄Co₂Mo₁₀O₃₈⁶⁻, 3Co²⁺ (Denoted Co₂Mo₁₀(Co)) with a Total Content Equal to 21.3% by Weight of MoO₃ and 5.5% by Weight of CoO with Respect to the Final Material in a Mesostructured Oxide Matrix Based on Silicon

An aqueous solution containing 2.10 mole/L of MoO₃ (Axens) and 12.6 mole/L of H₂O₂ was prepared with stirring at ambient temperature. A solution of Co(CO₃)₂ (Alfa Aesar) was then carefully introduced in order to avoid any exothermicity, in order to obtain a final concentration of 1.05 mole/L of Co(CO₃)₂. Raman analysis, carried out on the final material, revealed the presence of the Anderson HPAs H₆CoMo₆O₂₄³⁻, 3/2Co²⁺ and H₄Co₂Mo₁₀O₃₈⁶⁻, 3Co²⁺ as the major species. 2.94 mL of this 0.21 mole/L HPA solution was removed and added to a solution containing 10.6 g of TEOS which had been hydrolyzed for 16 hours in 18.9 g of water and 6.90 mg of HCl. A solution containing 3.79 g of F127 (BASF Corporation) and 12.8 mg of HCl in 18.7 g of water and 8.31 g of ethanol was prepared and stirred at ambient temperature for 16 h. The solution containing the HPA salts and the hydrolyzed TEOS was homogenized for 10 minutes and then mixed dropwise with the solution containing the F127. It was stirred together for 30 min then sent to the atomization chamber of the aerosol generator and the solution was sprayed in the form of fine droplets under the action of a vector gas (dry air) introduced under pressure (P=1.5 bars). The droplets were dried using the protocol described in the disclosure of the invention above. The temperature of the drying oven was fixed at 350° C. The recovered powder was then calcined in air for 5 h at T=550° C. The HPA salts were then regenerated by washing the solid with methanol for 2 hours using a Soxhlet. Finally, the solid was dried at 80° C. for 24 hours. The solid was characterized by small angle XRD, nitrogen volumetric analysis, TEM, SEM, XRF and Raman spectroscopy. The TEM analysis showed that the final material had an organized mesoporosity characterized by a vermicular structure. The result of the nitrogen volumetric analysis was a specific surface area of the final material of S_{BET}=328 m²/g and a mesopore diameter of 7.4 nm. Small angle XRD analysis highlighted a correlation peak at an angle 2θ=0.78. Bragg's law 2 d*sin(0.39)=1.5406 was used to calculate the correlation distance d between the pores of the mesostructured matrix, i.e. d=14.6 nm. The thickness of the walls of the matrix of the mesostructured material, defined by e=d−φ, was thus e=7.2 nm. A SEM image of the elementary spherical particles obtained indicated that these particles have a dimension characterized by a diameter of 50 to 700 nm, the size distribution of these particles being centred about 300 nm. The Raman spectrum of the final means exhibited characteristic bands of the two Anderson HPA salts: Co₂Mo₁₀(Co) at 957, 917, 602, 565, 355, 222 cm⁻¹ and CoMo₆(Co) at 952, 903, 575, 355, 222 cm⁻¹.

### Example 2

### Preparation of a Material B in Accordance with the Invention Having HPAs of the Keggin Type with Formula HPCoMo₁₁O₄₀⁶⁻, 3Co²⁺ and PMo₁₂O₄₀³⁻, 3/2Co²⁺ with a Total Content Equal to 20% by Weight of MoO₃ and 3.8% by Weight of CoO and 0.8% by Weight of P₂O₅ with Respect to the Final Material in a Mesostructured Oxide Matrix Based on Silicon

A solution containing 0.30 mole/L of H₃PMo₁₂O₄₀, 13H₂O was prepared at ambient temperature. 0.97 mole/L, with respect to the final solution, of Ba(OH)₂, 8H₂O and 1.31 mole/L, with respect to the final solution, of CoSO₄, 7H₂O were added to this solution. Following two hours of stirring, a precipitate of BaSO₄ was formed. This was separated from the solution by filtering twice in succession. The HPA salts were obtained by evaporating the filtrate to dryness. Raman analysis carried out on the final material revealed the presence of HPCoMo₁₁O₄₀⁶⁻ and PMo₁₂O₄₀³⁻ Keggin type HPAs. A solution containing 10.8 g of TEOS as well as 18.9 g of water and 6.90 mg of HCl was hydrolyzed for 16 h. Another solution was prepared by dissolving, over 16 h, 3.78 g of F127 in 8.30 g of EtOH as well as 35.1 g of water and 12.8 mg of HCl. At the end of the hydrolysis, 1.03 g of HPA salts were added to the solution containing the TEOS. After stirring for 10 min, this solution was added dropwise to the aquo-ethanolic solution of F127. It was stirred for 30 min then sent to the atomization chamber of the aerosol generator and the solution was sprayed in the form of fine droplets under the action of a vector gas (dry air introduced under pressure (P=1.5 bars). The droplets were dried using the protocol described in the above disclosure of the invention. The temperature of the drying oven was fixed at 350° C. The recovered powder was then calcined in air for 5 h at T=550° C. The HPA salts were then regenerated by washing the solid with methanol for 2 hours using a Soxhlet. Finally, the solid was dried at 80° C. for 24 hours. The solid was characterized by small angle XRD, nitrogen volumetric analysis, TEM, SEM, XRF and Raman spectroscopy. The TEM analysis showed that the final material had an organized mesoporosity characterized by a vermicular structure. The result of the nitrogen volumetric analysis was a specific surface area of the final material of S_{BET}=335 m²/g and a mesopore diameter of 7.4 nm. Small angle XRD analysis highlighted a correlation peak at an angle 2θ=0.78. Bragg's law 2 d*sin(0.39)=1.5406 was used to calculate the correlation distance d between the pores of the mesostructured matrix, i.e. d=14.6 nm. The thickness of the walls of the matrix of the mesostructured material, defined by e=d−φ was thus e=7.2 nm. A SEM image of the elementary spherical particles obtained indicated that these particles have a dimension characterized by a diameter of 50 to 700 nm, the size distribution of these particles being centred about 300 nm. The material obtained has a Raman spectrum exhibiting the characteristic bands of heteropolyanion salts of the Keggin type, HPCoMo₁₁O₄₀⁶⁻ and PMo₁₂O₄₀³⁻. The principal bands of HPCoMo₁₁O₄₀⁶⁻ are located at 232, 366, 943 and 974 cm⁻¹. The most intense characteristic band of this type of lacunary Keggin is located at 974 cm⁻¹. The principal bands of PMo₁₂O₄₀³⁻ are located at 251, 603, 902, 970 and 990 cm⁻¹. The most intense characteristic band of this Keggin HPA is located at 990 cm⁻¹.

### Example 3

### Preparation of a Material C in Accordance with the Invention Having HPAs of the Keggin Type with Formula PW₁₂O₄₀³⁻.3H⁺ (Commercial HPA) with a Total Content Equal to 23.5% by Weight of WO₃ and 0.6% by Weight of P₂O₅ with Respect to the Final Material. The Mesostructured Oxide Matrix is Based on Aluminium and Silicon, the Si/Al Molar Ratio being Equal to 0.37. Impregnation of Ni in a Total Content Equal to 2.6% by Weight of NiO with Respect to the Final Material

10.0 g of aluminium trichloride hexahydrate was dissolved in 21.1 g of water and 7.70 mg of HCl. After dissolving for 10 min, 3.21 g of TEOS was added. Hydrolysis of this solution was carried out for 16 h. A solution was prepared by dissolving 4.21 g of F127 in 36.9 g of water and 14.3 mg of HCl as well as 9.24 g of ethanol, the solution was stirred at ambient temperature for 16 h. 2.88 mL of an aqueous solution of H₃PW₁₂O₄₀ with 0.37 mole/L of HPA was added to the solution containing the hydrolyzed TEOS and the AlCl₃. After 10 min, this solution was added dropwise to the aquo-ethanolic solution of the surfactant. It was stirred together for 30 min then was sent to the spray chamber of the aerosol generator and the solution was sprayed in the form of fine droplets under the action of a vector gas (dry air) introduced under pressure (P=1.5 bars). The droplets were dried in accordance with the protocol described in the disclosure of the invention above. The temperature of the drying oven was fixed at 350° C. The recovered powder was then calcined in air for 5 h at T=550° C. The HPA was then regenerated by washing the solid with methanol for 2 hours using a Soxhlet. Finally, the solid was dried at 80° C. for 24 hours. The nickel promoter was deposited on the solid obtained by dry impregnation. The pore volume of the solid was filled up using an aqueous 1.02 mole/L nickel nitrate solution. The solution was added dropwise to the solid in accordance with a dry impregnation mode. The solid was allowed to mature for 12 h, then was oven dried at a temperature of 120° C. for 12 h. The solid was characterized by small angle XRD, by nitrogen volumetric analysis, by TEM, by SEM, by XRF and by Raman spectroscopy. The TEM analysis demonstrated that the final material had an organized mesoporosity characterized by a vermicular structure. Nitrogen volumetric analysis produced a specific surface area of the final material, S_{BET}=180 m²/g and a mesoporous diameter of 7.2 nm. Small angle XRD analysis highlighted a correlation peak at the angle 2θ=0.64. Bragg's law 2 d*sin(0.32)=1.5406 was used to calculate the correlation distance d between the pores of the mesostructured matrix, i.e. d=14.2 nm. The thickness of the walls of the matrix of the mesostructured material, defined by e=d−φ, was thus e=7.0 nm. A SEM image of the elementary spherical particles obtained indicated that these particles have a dimension characterized by a diameter of 50 to 700 nm, the size distribution of these particles being centred about 300 nm. The material obtained has a Raman spectrum exhibiting the characteristic bands of heteropolyanion salts of the Keggin type, PW₁₂O₄₀³⁻. The principal bands of PW₁₂O₄₀³⁻ are located at 216, 518, 990 and 1004 cm⁻¹.

### Example 4

### Preparation of a Material D in Accordance with the Invention Having HPAs of the Strandberg Type H₂P₂Mo₅O₂₃⁴⁻, with a Total Content Equal to 14% by Weight of MoO₃ and 2.9% by Weight of NiO and 2.8% by Weight of P₂O₅ with Respect to the Final Material in a Mesostructured Oxide Matrix Based on Aluminium and Silicon with a Si/Al Molar Ratio=0.5

An aqueous solution containing 3.61 mole/L of MoO₃, 1.44 mole/L of H₃PO₄, 1.44 mole/L of Ni(OH)₂ was prepared with stirring at ambient temperature. Raman analysis carried out on the final material revealed the presence of the Strandberg HPA H₂P₂Mo₅O₂₃⁴⁻ as the majority species. 8.60 g of aluminium trichloride hexahydrate was dissolved in 20.0 g of water and 7.30 mg of HCl. After dissolving for 10 min, 3.71 g of TEOS was added. Hydrolysis of this solution was carried out for 16 h. A solution was prepared by dissolving 4.01 g of F127 and 2.18 g of PPO (polypropylene oxide) in 35.7 g of water and 13.6 mg of HCl as well as 8.80 g of ethanol; the solution was stirred at ambient temperature for 16 h. 1.58 mL of an aqueous solution of H₂P₂Mo₅O₂₃⁴⁻, 0.72 mole/L in HPA, was added to the solution containing the hydrolyzed TEOS and AlCl₃. After 10 min, this solution was added dropwise to the aquo-ethanolic solution of the surfactant. It was stirred together for 30 min then was sent to the spray chamber of the aerosol generator and the solution was sprayed in the form of fine droplets under the action of a vector gas (dry air) introduced under pressure (P=1.5 bars). The droplets were dried in accordance with the protocol described in the disclosure of the invention above. The temperature of the drying oven was fixed at 350° C. The recovered powder was then calcined in air for 5 h at T=550° C. The HPA was then regenerated by washing the solid with methanol for 2 hours using a Soxhlet. Finally, the solid was dried at 80° C. for 24 hours. The solid was characterized by small angle XRD, by nitrogen volumetric analysis, by TEM, by SEM, by XRF and by Raman spectroscopy. The TEM analysis showed that the final material had an organized mesoporosity characterized by a vermicular structure. The nitrogen volumetric analysis provided a specific surface area of the final material of S_{BET}=180 m²/g and a mesoporous diameter of 8.5 nm. The small angle XRD analysis allowed a correlation peak to be observed at the angle 2θ=0.63. Bragg's law 2 d*sin (0.31)=1.5406 was used to calculate the correlation distance d between the pores of the mesostructured matrix, i.e. d=14 nm. The thickness of the walls of the matrix of the mesostructured material, defined by e=d−φ, was thus e=5.5 nm. A SEM image of the elementary spherical particles obtained indicated that these particles have a dimension characterized by a diameter of 50 to 700 nm, the size distribution of these particles being centred around 300 nm. The material obtained had a Raman spectrum exhibiting the characteristic bands of the Strandberg type heteropolyanion H₂P₂Mo₅O₂₃⁴⁻. The principal bands of H₂P₂Mo₅O₂₃⁴⁻ are located at 370, 395, 893 and 942 cm⁻¹. The most intense characteristic band of this type of Strandberg HPA is located at 942 cm⁻¹.

### Example 5

### Preparation of a Material E in Accordance with the Invention Having HPAs of the Keggin Type PVMo₁₁O₄₀⁴⁻, 2Ni²⁺, PV₂Mo₁₀O₄₀⁵⁻, 5/2Ni²⁺, PV₃Mo₉O₄₀⁶⁻.3Ni²⁺, and PV₄Mo₈O₄₀⁷⁻, 7/2Ni²⁺ With 12% by Weight of MoO₃, 1.1% by Weight of NiO and 0.69% by Weight of V₂O₅ with Respect to the Final Material in a Mesostructured Oxide Matrix Based on Aluminium and Silicon with a Si/al Molar Ratio=0.1

The HPA was obtained by dissolving molybdenum in the form of MoO₃ and phosphorus in the form of H₃PO₄ in water in respective concentrations of 1.88 mole/L and 0.17 mole/L then, following complete dissolution, with vanadium, V₂O₅, in a concentration of 0.085 mole/L. The Raman and phosphorus NMR analyses carried out on the final material revealed the presence of the substituted Keggin HPAs PVMo₁₁O₄₀⁴⁻, PV₂Mo₁₀O₄₀⁵⁻, PV₃Mo₉O₄₀⁶⁻ and PV₄Mo₈O₄₀⁷⁻, as the major species. 12.0 g of aluminium trichloride hexahydrate was dissolved in 19.7 g of water and 7.20 mg of HCl. After dissolving for 10 min, 1.04 g of TEOS was added. Hydrolysis of this solution was carried out for 16 h. A solution was prepared by dissolving 3.93 g of F127 and 2.19 g of PPO (polypropylene oxide) in 35.8 g of water and 13.3 mg of HCl as well as 8.63 g of ethanol, the solution was stirred at ambient temperature for 16 h. 1.45 mL of an aqueous solution of PVMo₁₁O₄₀⁴⁻, 4H⁺, 0.17 mole/L of HPA, was added to the solution containing the hydrolyzed TEOS and AlCl₃. After 10 min, this solution was added dropwise to the aquo-ethanolic solution of the surfactant. It was stirred together for 30 min then was sent to the spray chamber of the aerosol generator and the solution was sprayed in the form of fine droplets under the action of a vector gas (dry air) introduced under pressure (P=1.5 bars). The droplets were dried in accordance with the protocol described in the disclosure of the invention above. The temperature of the drying oven was fixed at 350° C. The recovered powder was then calcined in air for 5 h at T=550° C. The HPA was then regenerated by washing the solid with methanol for 2 hours using a Soxhlet. Finally, the solid was dried at 80° C. for 24 hours. The solid was characterized by small angle XRD, by nitrogen volumetric analysis, by TEM, by SEM, by XRF and by Raman spectroscopy. The TEM analysis showed that the final material had an organized mesoporosity characterized by a vermicular structure. The nitrogen volumetric analysis provided a specific surface area for the final material of S_{BET}=180 m²/g and a mesoporous diameter of 8.5 nm. The small angle XRD analysis allowed a correlation peak to be observed at the angle 2θ=0.63. Bragg's law 2 d*sin(0.31)=1.5406 was used to calculate the correlation distance d between the pores of the mesostructured matrix, i.e. d=14 nm. The thickness of the walls of the matrix of the mesostructured material, defined by e=d−φ, was thus e=5.5 nm. A SEM image of the elementary spherical particles obtained indicated that these particles have a dimension characterized by a diameter of 50 to 700 nm, the size distribution of these particles being centred around 300 nm.

The particles obtained thereby were then impregnated with a solution of nickel nitrate with a volume equal to the pore volume of the particles and such that the Ni/Mo ratio was equal to 0.35. The solid obtained was dried for 12 hours at 120° C. The Raman spectrum of the material obtained revealed the presence of a mixture of 4 Keggin heteropolyanions with formulae PVMo₁₁O₄₀⁴⁻, PV₂Mo₁₀O₄₀⁵⁻, PV₃Mo₉O₄₀⁶⁻ and PV₄Mo₈O₄₀⁷⁻, as demonstrated by the presence of an intense band at 981 cm⁻¹ accompanied by a shoulder at 967 cm⁻¹ and secondary bands at 888 cm⁻¹, 615 cm⁻¹, 478 cm⁻¹ and 256 cm⁻¹.

### Example 6

### Preparation of a Material F in Accordance with the Invention Having HPAs of the Strandberg Type, H₂P₂Mo₅O₂₃⁴⁻, 2Ni²⁺, with a Total Content Equal to 21% by Weight of MoO₃, 4.3% By Weight of NiO and 4.1% by Weight of P₂O₅ with Respect to the Final Material in a Mesostructured Oxide Matrix Based on Aluminium and Silicon with a Si/al Molar Ratio=0.1

An aqueous solution containing 3.61 mole/L of MoO₃, 1.44 mole/L of H₃PO₄, and 1.44 mole/L of Ni(OH)₂ was prepared with stirring at ambient temperature. Raman analysis carried out on the final material revealed the presence of the Strandberg HPA H₂P₂Mo₅O₂₃⁴⁻ as the majority species. 10.3 g of aluminium trichloride hexahydrate was dissolved in 20.2 g of water and 7.40 mg of HCl. After dissolving for 10 min, 0.89 g of TEOS was added. Hydrolysis of this solution was carried out for 16 h. A solution was prepared by dissolving 4.04 g of F127 in 34.9 g of water and 13.7 mg of HCl as well as 8.86 g of ethanol; the solution was stirred at ambient temperature for 16 h. 2.65 mL of an aqueous solution of H₂P₂Mo₅O₂₃⁴⁻, 0.72 mole/L of HPA, was added to the solution containing the hydrolyzed TEOS and AlCl₃. After 10 min, this solution was added dropwise to the aquo-ethanolic solution of the surfactant. It was stirred together for 30 min then was sent to the spray chamber of the aerosol generator and the solution was sprayed in the form of fine droplets under the action of a vector gas (dry air) introduced under pressure (P=1.5 bars). The droplets were dried in accordance with the protocol described in the disclosure of the invention above. The temperature of the drying oven was fixed at 350° C. The recovered powder was then calcined in air for 5 h at T=550° C. The HPA was then regenerated by washing the solid with methanol for 2 hours using a Soxhlet. Finally, the solid was dried at 80° C. for 24 hours. The solid was characterized by small angle XRD, by nitrogen volumetric analysis, by TEM, by XRF and by Raman spectroscopy. The TEM analysis showed that the final material had an organized mesoporosity characterized by a vermicular structure. The nitrogen volumetric analysis provided a specific surface area for the final material of S_{BET}=180 m²/g and a mesoporous diameter of 5.6 nm. The small angle XRD analysis allowed a correlation peak to be observed at the angle 2θ=0.64. Bragg's law 2 d*sin(0.32)=1.5406 was used to calculate the correlation distance d between the pores of the mesostructured matrix, i.e. d=13.1 nm. The thickness of the walls of the matrix of the mesostructured material, defined by e=d−φ, was thus e=7.5 nm. A SEM image of the elementary spherical particles obtained indicated that these particles had a dimension characterized by a diameter of 50 to 700 nm, the size distribution of these particles being centred around 300 nm. The material obtained had a Raman spectrum exhibiting the characteristic bands of the heteropolyanion of the Strandberg type, H₂P₂Mo₅O₂₃⁴⁻. The principal bands of H₂P₂Mo₅O₂₃⁴⁻ are located at 371, 394, 892 and 941 cm⁻¹. The most intense characteristic band of this type of Strandberg HPA is located at 941 cm⁻¹.

### Example 7

### Use of Material A as a Precursor of a Catalyst A_{S} for the Hydrodesulphurization of a Gasoline Cut from Model Molecules Representative of a Catalytically Cracked Gasoline

The catalyst obtained following sulphurization of the material A was evaluated on a model feed representative of a catalytically cracked gasoline (FCC) containing 10% by weight of 2,3-dimethylbut-2-ene and 0.33% by weight of 3-methylthiophene (i.e. 1000 ppm of sulphur with respect to the feed). The solvent used was heptane. The catalyst obtained following sulphurization of the material A was denoted A_{S}.

A conventional CoMo catalyst denoted Al containing 2.9% by weight of CoO and 10.3% by weight of MoO₃ supported on a transition alumina and having a specific surface area equal to 135 m²/g and a pore volume equal to 1.12 cm³/g was used as a reference. Cobalt and molybdenum present in this catalyst Al were not in the form of HPA.

The material A and the catalyst Al had been sulphurized ex situ in the gas phase at 500° C. for 2 h in a stream of H₂S in H₂ (15% by volume of H₂S in H₂). Thus, respectively, the catalysts A_{S} (in accordance with the invention) and A1_{S} (not in accordance with the invention) were obtained. The material A underwent a shaping step prior to the sulphurization step, said shaping step consisting of pelletization, crushing and sieving in order to recover only samples with a granulometry in the range 1 to 2 mm. The catalyst A1 was shaped in a manner analogous to material A.

The hydrodesulphurization reaction was carried out in a closed Grignard type reactor under a hydrogen pressure equal to 3.5 MPa, at 250° C. Each of the catalysts A_{S} and A1_{S} were placed in succession in said reactor. Samples were taken at different time intervals and analyzed by gas phase chromatography in order to observe the disappearance of the reagents.

The activity of the catalyst was expressed as the rate constant, kHDS, of the hydrodesulphurization reaction (HDS), normalized to the volume of the catalyst in the sulphide form, assuming a first order reaction with respect to the sulphur-containing compounds. The selectivity of the catalyst is expressed with respect to the normalized rate constants kHDS/kHDO, kHDO being the rate constant for the olefin hydrogenation reaction (HDO), namely in the present case for the 2,3-dimethylbut-2-ene hydrogenation reaction, normalized to the volume of catalyst in the sulphide form, assuming first order with respect to the olefins. The ratio kHDS/kHDO will be larger as the catalyst becomes more selective. An increase in the ratio kHDS/kHDO is thus favourable to the quality of the gasoline obtained at the end of the hydrodesulphurization reaction, provided that since olefin hydrogenation has been limited, the loss of octane number of the resulting gasoline is greatly minimized.

The results of the catalytic performances are presented in Table 1. The values are normalized by taking the conventional CoMo/alumina catalyst as a reference and taking kHDS/kHDO=100 and kHDS=100.

TABLE 1
Catalytic performances of the catalyst A_{S} on a model feed

| Catalyst | k HDS | kHDS/kHDO |
|---|---|---|
| CoMo/alumina (comparative catalyst | 100 | 100 |
| A1_{S}) | | |
| Catalyst A_{S} (in accordance with the | 105 | 132 |
| invention) | | |

The results shown in Table 1 demonstrate that a catalyst in which the non-sulphurized form (i.e. the oxide form) contains metallic particles in the form of heteropolyanions trapped in a mesostructured matrix can be used to significantly increase the selectivity without deterioration of the HDS activity with respect to the conventional catalyst A1_{S}. The catalyst A_{S} in accordance with the invention is more selective than the conventional catalyst: it limits the hydrogenation of 2,3-dimethylbut-2-ene to 2,3-dimethylbut-2-ane, allowing a better quality gasoline (better octane number) to be obtained than that obtained with the conventional catalyst A1_{S}. This means that for a low residual sulphur content in the gasolines, the octane number will be reduced to a far lesser extent using the catalyst A_{S} in accordance with the invention.

### Example 8

### Use of the Material B as a Precursor of a Catalyst B_{S} for the Hydrotreatment of a Straight Run Gas Oil Feed

In this example, the following was used as a reference catalyst (denoted B1): a CoMoP/alumina catalyst having the following composition: 21% by weight of MoO₃, 4.3% by weight of CoO and 4% by weight of P₂O₅ with respect to the final solid. It was supplied by Axens. Before in situ sulphurization, the material B and the catalyst B1 underwent a shaping step consisting of pelletization, crushing and screening in order to only recover samples with a granulometry in the range 1 to 2 mm.

The in situ sulphurization of the material B and catalyst B1 (30 cm³ of material B or catalyst B1 respectively mixed with 10 cm³ of SiC with a granulometry of 0.8 mm) was carried out at 50 bar, a HSV=2 h⁻¹, with a H₂/HC (hydrocarbons) ratio (volume flow rate) at the inlet=400 Std L/L. The sulphurization feed (gas oil supplemented with 2% dimethyldisulphide, Evolution from Arkema) was introduced into the reactor under H₂ when this reached 150° C. After one hour at 150° C., the temperature was increased with a ramp-up of 25° C./hour to 220° C., then with a ramp-up of 12° C./hour until a constant temperature stage of 350° C. was reached and held for 12 hours. The catalysts B_{S} (in accordance with the invention) and B1_{S} (not in accordance with the invention) were thus obtained.

Following sulphurization, the temperature was reduced to 330° C. and the test gas oil feed was injected. The catalytic test was carried out at a total pressure of 50 bar, the hydrogen being lost (no recycling), at a HSV=2 h⁻¹, with a H₂/HC volume ratio at the inlet of 400 Std L/L (flow rate H₂=24 Std l·h⁻¹, flow rate of feed=60 cm³·h⁻¹) and at 340° C.

In order to be able to evaluate the performances of the catalysts B_{S} and B1_{S} in HDS, and to compensate for the presence of H₂S in the effluents, the receptacle containing the effluents was stripped with nitrogen in an amount of 10 l·h⁻¹.

The gas oil used here was obtained from a heavy Arab crude. It contained 0.89% by weight of sulphur, 100 ppm by weight of nitrogen, 23% by weight of aromatic compounds. Its weighted mean temperature (WMT) was equal to 324° C. and its density was equal to 0.848 g/cm³. The WMT is defined as the ratio [(T₅+2T₅₀+4T₉₅)/7] where Tₓ corresponds to the temperature at which “x”% by weight is distilled. The WMT thus takes into account the temperature at which 5% by weight of the feed is vaporized, the temperature at which 50% by weight of the feed is vaporized and the temperature at which 95% by weight of the feed has been vaporized.

The performances of the catalysts B_{S} and B1_{S} are given in Table 2. They are expressed as the relative activity, setting that of catalyst B1_{S} as equal to 100 and assuming that they are of the apparent order of 1.5 with respect to the sulphur. The relationship linking the activity and the hydrodesulphurization conversion (% HDS) is given by the following formula:

$${A}_{HDS} = \sqrt{\frac{100}{100 - \% HDS}} - 1$$

where % HDS corresponds to the hydrodesulphurization conversion, HDS, and is defined by the following formula:

$$\% HDS = \frac{{S}_{feed} - {S}_{effluent}}{{S}_{feed}} \times 100$$

with S representing sulphur.

The results obtained for hydrodesulphurization during this test are recorded in Table 2 in which the catalyst B_{S} in accordance with the invention was compared with the industrial catalyst B1_{S}.

TABLE 2
Relative activity (at iso-volume of catalyst) in the HDS of straight
run gas oil using catalysts B_{S} and B1_{S} at T = 340° C.

| | A_{HDS} relative at iso-volume |
|---|---|
| Catalyst B1_{S} (comparative) | 100 |
| Catalyst B_{S} (invention) | 117 |

The results shown in Table 2 demonstrate the large gain in HDS activity obtained by means of the catalyst B_{S} in accordance with the invention compared with the commercial catalyst B1_{S}.

### Example 9.1

### Use of the Material C as a Precursor of a Catalyst C_{S} for the Hydrogenation of Toluene in the Presence of Aniline

The Hydrogenation of Toluene in the presence of Aniline test (“HTA” test) is intended to evaluate the hydrogenating activity (HYD) of supported sulphurized catalysts in the presence of H₂S and under hydrogen pressure. The isomerization and cracking which characterize the acid function of a hydroconversion catalyst are inhibited by the presence of NH₃ (following decomposition of the aniline) such that the HTA test can be used to specifically evaluate the hydrogenating power of each of the test catalysts. The aniline and/or NH₃ will thus react via an acid-base reaction with the acidic sites of the support. Each HTA test was carried out on a unit comprising several microreactors in parallel. For each HTA test, the same feed was used for the sulphurization of a catalyst and for the catalytic test phase proper. 4 cm³ of catalyst mixed with 4 cm³ of carborundum (SiC, 60 μm) were charged into the reactors.

The feed used for this test was as follows:

| | |
|---|---|
| Toluene | 20% by weight, |
| Cyclohexane | 73.62% by weight, |
| DMDS (dimethyldisulphide) | 5.88% by weight (3.8% by weight of S), |
| Aniline | 0.5% by weight (750 ppm N). |

The material C was charged into the reactors in its oxide, inactive, form. Activation (sulphurization) was carried out in the unit with that same feed. The H₂S formed following the decomposition of DMDS is what sulphurizes the oxide phase. The quantity of aniline present in the feed was selected in order to obtain approximately 750 ppm of NH₃ after decomposition. Following sulphurization, the catalyst denoted C_{S} was obtained. Before charging, the material C underwent a shaping step consisting of pelletization, crushing and screening so as to recover only samples with a granulometry in the range 1 to 2 mm.

The operating conditions of the toluene hydrogenation test were as follows:
P=6 MPa,
HSV=2 h⁻¹ (flow rate of feed=8 cm³/h),
H₂/HC=450 NL/L, (H₂ flux=3.6 NL/L),
T=350° C.

The percentage of toluene converted was evaluated and, by assuming first order for the reaction, the hydrogenating activity was deduced therefrom using the following relationship:

$${AH}_{1 \cdot order} = ln \frac{100}{( 100 - \% {HYD}_{toluene} )}$$

with % HYDₜₒₗᵤₑₙₑ=percentage of toluene converted.

A commercial catalyst denoted C1 with formulation NiW (27% by weight of WO₃) prepared on a silica alumina type support and comprising 30% by weight of silica in the support was shaped and sulphurized using identical protocols to those respectively carried out to obtain the catalyst C_{S}. The catalyst C1_{S} was thus obtained, which had an activity of 100, taken as the reference. The catalyst C_{S} (in accordance with the invention) had a relative activity equal to 105 with respect to the commercial catalyst C1_{S}, which demonstrates that the catalyst of the invention has a hydrogenating activity per atom of W which is much higher than the commercial catalyst which has 14% more W atoms than the catalyst of the invention. Thus, the catalyst C_{S} can be used to generate the same hydrogenating activity as a commercial catalyst which is charged with 14% more atoms of W in addition compared with a catalyst C_{S} of the invention.

### Example 9.2

### Evaluation of Catalysts C′_{S} (Invention) and C1′_{S} (not in Accordance with the Invention) in Mild Hydrocracking of VD

The feed used was a vacuum distillate (VD) type feed with the principal characteristics summarized in the table below.

| Feed | VD |
|---|---|
| Density_{15/4} (g/cm³) | 0.894 |
| S, organic (% by weight) | 0.3120 |
| N, organic (ppm) | 390 |
| WMT* (° C.) | 451 |
| % by volume of | 12.3 |
| compounds having a | |
| boiling point of less than | |
| 370° C. | |

$\begin{matrix}\text{*} weighted mean temperature = \frac{1 {T}_{5 \%} + 2 {T}_{50 \%} + 4 {T}_{95 \%}}{7} with {T}_{x \%} \\ corresponding to the boiling point of x \% of the hydrocarbon compounds \\ present in the liquid cut .\end{matrix}$

This feed was supplemented with DMDS and aniline in order to have 2% by weight of sulphur and 900 ppm of N.

4 cm³ of the material C in the oxide form then 4 cm³ of catalyst C1 were charged into the reactors. Activation (sulphurization) was carried out in the reaction unit before starting the test with the feed described above. Following decomposition of the DMDS, H₂S is what actually sulphurizes the material C. The respective catalysts C′_{S} and C1′_{S} were obtained.

The operating conditions applied during the test were as follows:
P=6 MPa,
HSV=0.6 h⁻¹,
H₂/HCₒᵤₜₗₑₜ=480 NL/L,
T=380° C.

The catalytic results are summarized in Table 3. The gross conversion corresponds to the conversion of the hydrocarbon fraction with a boiling point of more than 370° C. present in the initial VD feed into hydrocarbons with a boiling point of less than 370° C. present in the effluent. The gross conversion was determined as being equal to the fraction by weight constituted by hydrocarbons with a boiling point of less than 370° C. present in the effluent.

The catalytic results are summarized in Table 3 below. The catalyst C′_{S} in accordance with the invention can be used to maintain the gross conversion at a level as high as the commercial catalyst C1′_{S} even though it contains 14% fewer tungsten atoms. The catalyst C′_{S} is thus as active as the commercial catalyst C1′_{S} and has a hydrodesulphurization activity which is as high as that of the commercial catalyst C1′_{S}.

TABLE 3
Catalytic performances obtained for the catalysts
C'_{S} and C1'_{S} for mild hydrocracking.

| | Gross conversion | Total sulphur in the effluent |
|---|---|---|
| | (%) | (ppm) |
| Commercial catalyst | 32 | 60 |
| C1'_{S} (comparative) | | |
| Catalyst C'_{S} (invention) | 32 | 59 |

### Example 10

### Use of the Material D as a Precursor of a Catalyst D_{S} for the Hydroconversion of Heavy Hydrocarbon Cuts. Evaluation of Catalytic Performances in Ebullated Bed Mode on the Feed DAO C7

The hydrocarbon feed tested was a deasphalted oil (DAO) with the characteristics shown in Table 4.

TABLE 4
Characteristics of the DAO C7 feed.

| | Deasphalted oil |
|---|---|
| Feed | |
| density d15/4 | 0.9940 |
| Sulphur (% by wt) | 5.33 |
| Nitrogen (% by wt) | 2720 |
| Viscosity (cSt) | 198.5 |
| T_{viscosity measurement} (° C.) | 100 |
| Conradson carbon (% by wt) | 10.8 |
| Ni (ppm by wt) | 12 |
| V (ppm by wt) | 34.9 |
| Distillation in accordance | |
| with standard D1160 | |
| D1160-IP (initial point) | 302.3 |
| D1160-10% vol | 508 |
| D1160-20% vol | 551 |
| D1160-30% vol | 582 |
| D1160-40% vol | 603 |
| D1160-50% vol | 618 |
| D1160-FP ° C. | 620 |

The tests were carried out in a pilot unit equipped with an ebullated bed reactor. The catalyst was ebullated constantly throughout the test. Before carrying out the sulphurization step, the material D underwent a step for shaping consisting of pelletization, crushing and screening so as to recover only samples with a granulometry in the range 1 and 2 mm.

Initially, a step for sulphurization of the material D was carried out: 1 litre of material D was charged into the reactor, then a gas oil from distillation supplemented with dimethyldisulphide was supplied to the reactor while the temperature was gradually raised to 343° C. The catalyst D, was thus obtained. The feed (deasphalted oil) was then injected and the temperature was adjusted to 430° C. at 110 bars total pressure. The hourly space velocity was fixed at 1.2 L_{feed}/L_{catalyst}/h. The hydrogen flow rate corresponded to a ratio of 800 L/L of charge.

The operating conditions were of the isothermal type, which meant that the deactivation of the catalyst Dₛ could be monitored over time. The time in this case was expressed in barrels of feed/pound of catalyst (bbl/lb), which represents the cumulative quantity of feed passed over the catalyst with respect to the catalyst mass.

The catalytic performances are expressed as:
degree of conversion of residue (% by wt) HD540°⁺=100×[(% by wt of 540°⁺)_{feed}−(% by wt of 540°⁺)_{effluent}]/(% by wt of 540°⁺)_{feed}
degree of conversion of Conradson carbon HDCCR=100×(CCR_{feed}−CCR_{effluent})/CCR_{feed}
degree of desulphurization, HDS (% by wt)=[(% by wt S)_{feed}−(% by wt S)_{effluent}]/[(% by wt S)_{feed}]*100
degree of denitrogenation, HDN(% by wt)=[(% by wt N)_{feed}−(% by wt N)_{effluent}]/[(% by wt N)_{feed}]*100.
   The results shown in Table 5 are those obtained in the steady state.

TABLE 5
Catalytic results, steady state (4.1 bbL/Lb).

| | HD540°⁺ | HDCCR | HDS | HDN |
|---|---|---|---|---|
| Catalyst Dₛ 1.6 bbl/lb | 51 | 40 | 87 | 70 |

Thus, it appears that the hydroconversion process of the invention carried out in the presence of the catalyst Dₛ, obtained following sulphurization of the material D in accordance with the invention, results in satisfactory catalytic performances.

### Example 11

### Use of the Material E as a Precursor of a Catalyst Eₛ for the Two Step Hydrotreatment of Heavy Hydrocarbon Cuts. Evaluation of Catalytic Performances in Fixed Bed Mode on an Atmospheric Residue Feed

The test carried out in this example illustrates a hydrotreatment process comprising a hydrodemetallization step (HDM) followed by a hydrodesulphurization step (HDS), each of said steps being carried out in a fixed bed tube reactor, disposed in series one with respect to the other. The catalytic evaluation of the catalyst E_{S}, obtained following sulphurization of the material E, was carried out in this configuration: it was placed downstream of a conventional HDM catalyst with a NiMoP/alumina composition (9% by wt MoO₃, 1.85% by wt NiO, 1.78% by wt P₂O₅, multimodal delta alumina).

The feed was constituted by an atmospheric residue (AR) of Middle Eastern origin (Arabian Light). This residue is characterized by a high viscosity (45 mm²/s), high Conradson carbon contents (10.2% by weight) and high C7 asphaltenes contents (3.2% by weight) and a high nickel (10.6 ppm by weight), vanadium (41 ppm by weight) and sulphur (3.38% by weight) content. The complete characteristics of the feed are reported in Table 6.

TABLE 6
Characteristics of atmospheric residue to be hydrotreated.

| | |
|---|---|
| Density 15/4 | 0.9712 |
| Viscosity at 100° C. | 45 mm²/s |
| Sulphur | 3.38% by wt |
| Nitrogen | 2257 ppm |
| Nickel | 10.6 ppm |
| Vanadium | 41.0 ppm |
| Aromatic carbon | 24.8% |
| Conradson carbon | 10.2% by wt |
| (CCR) | |
| C7 asphaltenes | 3.2% by wt |
| Asphaltenes | 3.5% by wt |
| Simulated distillation | |
| IP (initial distillation | 219° C. |
| point) | |
| 5% | 299° C. |
| 10% | 342° C. |
| 20% | 409° C. |
| 30% | 463° C. |
| 40% | 520° C. |
| 50% | 576° C. |
| 80% | 614° C. |

The first reactor was charged with 3 mL of conventional HDM catalyst and the second reactor was charged with 3 mL of material E of the invention (acting as a HDS catalyst after sulphurization). In each reactor, the solid (namely the HDM catalyst in the first reactor and the material E in the second reactor) was diluted with 200 micron silicon carbide.

Since the material E had been prepared in the form of elementary spherical particles with a diameter of 50 to 700 nm centred about 300 nm, a prior shaping step was carried out before charging into the reactor. This shaping step consisted of pelletization, crushing and screening so as to recover only samples with a granulometry in the range 1 and 2 mm. A settled packing density (SPD, mass of catalyst for a given volume following settling) was then measured and the second reactor was charged with 3 mL of shaped material E.

The flow of fluids (oil residues+hydrogen recycle) was downwards in each of the reactors. This type of unit is representative of the operation of the reactors of the HYVAHL® unit for fixed bed residue hydrotreatment. The HDM catalyst can be used to significantly reduce the asphaltenes content upstream of the catalyst Eₛ in accordance with the invention.

Following a step for sulphurization by circulating a gas oil cut supplemented with DMDS in each of the reactors at a final temperature of 350° C., the unit was operated with the atmospheric residue described above under the operating conditions of Table 7.

TABLE 7
Operating conditions employed

| | |
|---|---|
| Total pressure | 15 MPa |
| Test temperature | 370° C. |
| Hourly space velocity of residue | 0.2 h⁻¹ |
| Flow rate of hydrogen | 1000 std L._{H2}/L._{feed} |

The atmospheric residue was injected into the first reactor then heated to the test temperature. After a stabilization period of 300 hours, the hydrodesulphurization (degree of HDS), hydrodemetallization (degree of HDM), Conradson carbon elimination (degree of HDCCR), C7 asphaltenes elimination (degree of HDAsC7) and hydrodenitrogenation (degree of HDN) performances were recorded and are presented in Table 8.

The degree of HDS is defined as follows:

HDS (% by wt) ((% by wt S)_{feed}−(% by wt S)_{effluent})/(% by wt S)_{feed}×100.

The level of HDM is defined as follows:
HDM (% by wt)=((ppm by wt Ni+V)_{feed}−(ppm by wt Ni+V)_{effluent})/(ppm by wt Ni+V)_{feed}×100.

Using the same principle, a degree of HDCCR (HDCCR (% by wt) ((% by wt CCR)_{feed}−(% by wt CCR)_{effluent})/(% by wt CCR)_{feed}×100) can be defined for the elimination of Conradson carbon, a degree of HDAsC7 (HDAsC7 (% by wt)=((% by wt ASC7)_{feed}−(% by wt HDAsC7)_{effluent})/(% by wt HDAsC7)_{feed}×100) for the elimination of C7 asphaltenes and finally a degree of HDN (HDN (% by wt)=((% by wt N)_{feed}−(% by wt N)_{effluent})/(% by wt N)_{feed}×100) for the elimination of nitrogen.

TABLE 8
Performances of catalyst Eₛ in HDS/HDM/HDN/HDCCR/HDAsC7

| | HDS | HDM | HDN | HDCCR | HDAsC7 |
|---|---|---|---|---|---|
| | (% by | (% by | (% by | (% by | (% by |
| | weight) | weight) | weight) | weight) | weight) |
| HDM catalyst + | 77 | 63 | 49 | 64 | 78 |
| Catalyst E_{S} (50/50) | | | | | |

Thus, it appears that the hydrotreatment process of the invention combining a step for hydrodemetallization pre-treatment and a step for hydrodesulphurization in the presence of catalyst E_{S}, obtained following sulphurization of the material E in accordance with the invention, results in both good HDS activity and good HDM activity. The catalyst Eₛ can also be used to reach a highly satisfactory level of nitrogen, CCR and asphaltenes elimination. These good performances can be attributed to optimal transport of reagents within the catalyst and to optimized dispersion of metals, in particular vanadium and molybdenum.

### Example 12

### Use of the Material F as a Precursor for a Catalyst Fₛ for the Hydrotreatment of a Feed Obtained from a Renewable Source. Evaluation of Catalytic Performances Using a Rapeseed Oil

50 mL/h of pre-refined rapeseed oil with a density of 920 kg/m³ having a sulphur content of less than 10 ppm and a cetane index equal to 35 was introduced into an isothermal fixed bed reactor charged with 100 mL of material F. 700 Nm³ of hydrogen/m³ of feed was introduced into the reactor maintained at a temperature of 300° C. and at a pressure of 5 MPa.

The principal characteristics of the rapeseed oil feed used in the hydrotreatment process illustrated here are recorded in Table 9.

The feed constituted by rapeseed oil contained triglycerides the hydrocarbon chains of which contained 14 to 24 carbon atoms and contained only even numbers of carbon atoms. The triglycerides nomenclature is in the form a:b, with a corresponding to the number of carbon atoms of each of the hydrocarbon chains of the triglycerides and b corresponding to the number of carbon-carbon double bonds present on each of said hydrocarbon chains.

TABLE 9
characteristics of the rapeseed oil feed.

| Properties of feed | Values |
|---|---|
| Elemental analysis | |
| S [ppm by wt] | 4 |
| N [ppm by wt] | 23 |
| P [ppm by wt] | 177 |
| C [% by wt] | 77.2 |
| H [% by wt] | 11.6 |
| O [% by wt] | 11.2 |
| Fatty acid composition (%) | |
| 14:0 | 0.1 |
| 16:0 | 5.0 |
| 16:1 | 0.3 |
| 18:0 | 1.5 |
| 18:1 trans | <0.1 |
| 18:1 cis | 60.2 |
| 18:2 trans | <0.1 |
| 18:2 cis | 20.5 |
| 18:3 trans | <0.1 |
| 18:3 cis | 9.6 |
| 20:0 | 0.5 |
| 20:1 | 1.2 |
| 22:0 | 0.3 |
| 22:1 | 0.2 |
| 24:0 | 0.1 |
| 24:1 | 0.2 |

The material F in accordance with the invention was sulphurized in situ at a temperature of 350° C. using a straight run gas oil feed supplemented with 2% by weight of dimethyldisulphide (DMDS). After sulphurization in situ in the reaction unit under pressure to produce the catalyst Fₛ, the rapeseed oil described in Table 9 was sent to the reaction unit.

In order to maintain the catalyst Fₛ in the sulphurized state, 50 ppm by weight of sulphur in the form of DMDS was added to the rapeseed oil. Under the reaction conditions, the DMDS was completely decomposed to form methane and H₂S. The operating conditions for carrying out the hydrotreatment process and the catalytic results obtained are shown in Table 10.

TABLE 10
Operating conditions and catalytic performances for the hydrotreatment
of a rapeseed oil in the presence of catalyst Fs.

| | |
|---|---|
| Operating conditions | |
| Temperature [° C.] | 300 |
| Pressure [MPa] | 5 |
| H₂/feed [Nm³/m³] | 700 |
| Yields of products formed | |
| C₁-C₇ cut [% by weight] | 5.1 |
| 150° C. + cut (kerosene (150-250° C.) and | 85.4 |
| gas oil (250° C.+) [% by weight] | |

The 150° C.+ cut produced (i.e. with a boiling point of 150° C. or more) was primarily constituted by linear paraffins (nC₁₄ to nC₂₄). These paraffins have an excellent cetane index (>70) and are entirely compatible with diesel fuel of fossil origin. Thus, the catalyst Fₛ in accordance with the invention can be used for the production of a gas oil base (boiling point of more than 250° C.) of very high quality which can be incorporated as a mixture into crude oil-based diesel as well as for the production of a kerosene base (boiling point in the range 150° C. to 250° C.) which can be incorporated as a mixture into the crude oil-based kerosene. The hydrotreated products (kerosene and gas oil) represent 85.4% by weight of the products formed. The yields of the products formed were calculated from a gas chromatographic analysis.

1. An inorganic material constituted by at least two elementary spherical particles, each of said spherical particles comprising metallic particles in the form of a polyoxometallate with formula (XₓMₘO_{y}Hₕ)^{q-}, where H is a hydrogen atom, O is an oxygen atom, X is an element selected from phosphorus, silicon, boron, nickel and cobalt and M is one or more elements selected from vanadium, niobium, tantalum, molybdenum, tungsten, iron, copper, zinc, cobalt and nickel, x being equal to 0, 1, 2, or 4, m being equal to 5, 6, 7, 8, 9, 10, 11, 12 or 18, y being in the range 17 to 72, h being in the range 0 to 12 and q being in the range 1 to 20 (y, h and q being whole numbers), said metallic particles being present within a mesostructured matrix based on an oxide of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium and a mixture of at least two of these elements, said matrix having pores with a diameter in the range 1.5 to 50 nm and having amorphous walls with a thickness in the range 1 to 30 nm, said elementary spherical particles having a maximum diameter of 200 microns.

2. A material according to claim 1, in which said mesostructured matrix is constituted by aluminium oxide, silicon oxide or a mixture of silicon oxide and aluminium oxide.

3. A material according to claim 1, in which said matrix has pores with a diameter in the range 4 to 20 nm.

4. A material according to claim 1, in which said matrix has amorphous walls with a thickness in the range 1 to 10 nm.

5. A material according to claim 1, in which the element M present in said metallic particles with formula (XₓMₘO_{y}Hₕ)^{q-} is one or more elements selected from vanadium, niobium, tantalum, molybdenum, tungsten, cobalt and nickel.

6. A material according to claim 1, in which said metallic particles in the form of a polyoxometallate are selected from isopolyanions and heteropolyanions (HPA).

7. A material according to claim 1, in which said metallic particles are heteropolyanions with the formula XM₆O₂₄Hₕ^{q-} (with x=1, m=6, y=24, q=3 to 12 and h=0 to 12) and/or the formula X₂M₁₀O₃₈Hₕ^{q-} (with x=2, m=10, y=38, q=3 to 12 and h=0 to 12).

8. A material according to claim 1, in which said metallic particles are heteropolyanions with the formula XM₁₂O₄₀Hₕ^{q-} (x=1, m=12, y=40, h=0 to 12, q=3 to 12) and/or the formula XM₁₁O₃₉Hₕ^{q-} (x=1, m=11, y=39, h=0 to 12, q=3 to 12).

9. A material according to claim 1, in which said metallic particles are heteropolyanions with the formula HₕP₂Mo₅O₂₃^{(6-h)-}, with h=0, 1 or 2.

10. A material according to claim 1 in which each of said spherical particles comprises zeolitic nanocrystals trapped in said mesostructured matrix with said metallic particles.

11. A material according to claim 1 in which each of the spherical particles comprises one or more additional element(s) selected from organic agents, metals from group VIII of the periodic classification of the elements and doping species belonging to the list of doping elements constituted by phosphorus, fluorine, silicon and boron and their mixtures.

12. A process for the preparation of a material according to claim 1, comprising at least the following steps in succession:
a) mixing in solution:
at least one surfactant;
at least one precursor of at least one element Y selected from the group constituted by silicon, aluminium, titanium, tungsten, zirconium, gallium, germanium, tin, antimony, lead, vanadium, iron, manganese, hafnium, niobium, tantalum, yttrium, cerium, gadolinium, europium and neodymium, and a mixture of at least two of these elements;
metallic particles in the form of a polyoxometallate with formula (XₓMₘO_{y}Hₕ)^{q-} where H is a hydrogen atom, O is an oxygen atom, X is an element selected from phosphorus, silicon, boron, nickel and cobalt and M is one or more elements selected from vanadium, niobium, tantalum, molybdenum, tungsten, iron, copper, zinc, cobalt and nickel, x being equal to 0, 1, 2 or 4, m being equal to 5, 6, 7, 8, 9, 10, 11, 12 or 18, y being in the range 17 to 72, h being in the range 0 to 12 and q being in the range 1 to 20, or at least one metallic precursor of said metallic particles;
optionally, at least one colloidal solution in which zeolite crystals with a maximum nanometric dimension equal to 300 nm are dispersed;
b) aerosol atomisation of said solution obtained in step a) in order to result in the formation of spherical liquid droplets; c) drying said droplets; d) eliminating at least said surfactant.

13. A process for the transformation of a hydrocarbon feed comprising 1) bringing a mesostructured inorganic material according to claim 1 into contact with a feed comprising at least one sulphur-containing compound, then 2) bringing said material obtained from said step 1) into contact with said hydrocarbon feed.

14. A transformation process according to claim 13, in which said process is a process for the hydrodesulphurization of a gasoline cut.

15. A transformation process according to claim 13, in which said process is a process for the hydrodesulphurization of a gas oil cut.

16. A transformation process according to claim 13, in which said process is a process for hydrocracking a hydrocarbon feed in which at least 50% of its compounds have an initial boiling point of more than 340° C. and a final boiling point of less than 540° C.

17. A transformation process according to claim 13, in which said process is a process for the hydroconversion of a heavy hydrocarbon feed in which at least 55% by weight of its compounds have a boiling point of 540° C. or more.

18. A transformation process according to claim 13, in which said process is a process for the hydrotreatment of a heavy hydrocarbon feed in which at least 50% by weight of the hydrocarbon compounds present in said charge have a boiling point which is greater than or equal to 370° C.

19. A transformation process according to claim 13, in which said process is a process for the hydrotreatment of a hydrocarbon feed comprising triglycerides.
